(19) United States
(12) Patent Application Publication
(10) Pub. No.: US 2003/0195024 A1
(43) Pub. Date: Oct. 16, 2003

(54) System and method of displaying a game on a gaming machine

(75) Inventor: Warren William Slattery, Melbourne (AU)

Correspondence Address: OLIFF & BERRIDGE, PLC, P.O. BOX 19928, ALEXANDRIA, VA, 22320, US

(73) Assignee: INREACH COMMUNICATIONS PTY LTD, Melbourne (AU)

(21) Appl. No.: 10/369,590

(22) Filed: Feb. 21, 2003

Related U.S. Application Data
(63) Continuation of application No. PCT/AU01/01062, filed on Aug. 25, 2001.

(30) Foreign Application Priority Data
Aug. 25, 2000 (AU) PQ 9680

(51) Int. Cl. A63F 13/00

(52) U.S. Cl. 463/9; 463/16

(57) ABSTRACT

A gaming machine includes a display (1), an audio sequence player, a controller and a ticket dispenser (5). Additional features include an aesthetically designed casing (6), a secondary display (7) and a number of speakers (8). The preferred method involves displaying a number of game segments on the display (1) and displaying a video sequence before, during and after one of the game segments. The video sequence shows an animated character interacting with another animated character, performing a task or interacting with a user.

### FIELD OF THE INVENTION

The present invention relates to a system and method of displaying a game on a gaming machine and, in particular relates to a method of displaying video sequences interspersed with normal gaming machine reel segments to add significant entertainment value to the game.

The invention has been developed primarily for use with gaming machines employing real or virtual spinning reels with images and it will be described hereinafter with reference to that application. However, it will be appreciated that the invention is not limited to this particular field of use and is also suitable to other gaming machines.

### BACKGROUND

Known gaming machines, often called “poker machines” or “slot machines”, provide a limited amount of entertainment value to the user or gamer. Such games typically alternate between the display of spinning reels and the display of a double-up option. In this double-up option the user attempts to double the amount of credits won in the game segment. Not only are the varieties of gaming sequences limited, the graphics used on typical gaming machines are also fairly primitive. This is a result of a number of factors, including inertia on behalf of the gamers and a desire of the machine manufacturers, the establishment operators and the gaming software programmers to amortise the cost of the hardware over as long a time frame as possible.

The software updates of the games are related to the graphics or theme of the game. What invariably results is that some themes are more popular than others, in that it is known for gamers to queue to play at a machine with one theme, while machines with other themes are not used. At a lesser extreme, some themes generate considerably more turnover than others. Regardless of the volume of the turnover generated, the lifetime of any game is very limited and the machines require the regular turnover of software in an attempt to maintain the attention of the gamer.

Any discussion of the prior art throughout the specification should in no way be considered as an admission that such prior art is widely known or forms part of common general knowledge in the field.

### BROAD DISCLOSURE OF THE INVENTION

It is an object of the present invention to provide a system and method of displaying a game on a gaming machine which will overcome or substantially ameliorate at least one of the deficiencies of the prior art, or at least provide a useful alternative.

According to a first aspect of the invention there is provided a method of displaying a game on a gaming machine including a display, the method including the steps of:

(a) displaying a plurality of game segments on the display;

(b) displaying a video sequence before, during or after one or more of the game segments.

Preferably, the video sequence shows an animated character doing one or more of:

(i) interacting with another animated character;

(ii) performing a task; or

(iii) interacting with a user.

Preferably, the step of displaying a video sequence showing an animated character interacting with another animated character includes the step of displaying the character in a special feature sequence.

Preferably, the step of displaying the character in a special feature sequence includes the step of displaying the character doing one or more of:

(a) acting out a sketch;

(b) telling a joke; or

(c) observing or participating in a sport related situation.

Preferably, the sketch is a situational comedy sketch.

Preferably, the situational comedy sketch includes adult humour.

Preferably, the joke includes adult humour.

Preferably, the step of displaying a video sequence showing an animated character performing a task includes the step of displaying the character in an animated win-or-lose reward shot sequence.

Preferably, the step of displaying the character in an animated win-or-lose reward shot sequence includes the steps of:

(a) displaying the animated character on the display;

(b) displaying the animated character performing a task having a goal, which it may succeed or fail at achieving;

(c) identifying the win-or-lose result as a win result if the character succeeds in achieving the goal; and

(d) identifying the win-or-lose result as a lose result if the character fails in achieving the goal.

Preferably, the task is a sport-related task.

Preferably, the sport related task includes one or more of:

(i) shooting a basketball towards a basketball hoop, wherein the goal includes getting the basketball through the hoop;

(ii) hitting a golf ball towards a hole, wherein the goal includes getting the golf ball into the hole;

(iii) hitting a snooker ball towards a hole, wherein the goal includes getting the snooker ball into the hole;

(iv) rolling a lawn bowls ball towards a jack, wherein the goal includes getting the ball closest to the jack;

(v) serving a tennis ball, wherein the goal includes serving an ace;

(vi) serving a table tennis ball, wherein the goal includes serving an ace;

(vii) bowling a ten-pin bowling ball towards ten pins, wherein the goal includes getting a strike;

(viii) shooting at a clay pigeon target, wherein the goal includes hitting the pigeon;

(ix) marlin fishing, wherein the goal includes catching the marlin;

(x) diving off a poolside diving board, wherein the goal includes receiving a perfect score from the judges;

(xi) waterskiing over a ramp, wherein the goal includes landing safely; or

(xii) serving a volleyball wherein the goal includes serving an ace.

Preferably, the tasks are arranged into themes which determine at least the background and costumes of the animated characters.

Preferably, the themes include one or more of:

(i) a Carribean theme;

(ii) a Chinese theme;

(iii) an African theme;

(iv) an American theme;

(v) an English theme;

(vi) an Italian theme;

(vii) an Australian theme; and

(viii) a Japanese theme.

Preferably, the step of displaying a video sequence showing an animated character interacting with a user includes the step of displaying the character doing one or more of:

(a) making a win statement; or

(b) making a lose statement.

Preferably, the step of displaying the character making a win statement includes displaying the character expressing excitement.

Preferably, the step of displaying the character making a win statement includes displaying the character saying one or more of:

(a) “You beauty”;

(b) “You bloody beauty”;

(c) “Alright”; or

(d) “Ahh, magic”.

Preferably, each animated character has its own unique win statement.

Preferably, the step of displaying the character making a lose statement includes displaying the character expressing dismay at losing.

Preferably, the step of displaying the character making a lose statement includes displaying the character saying one or more of:

(a) “Damn it”

(b) “That sucks”;

(c) “Get out”; or

(d) “Ah, forget it”.

Preferably, the step of displaying the character making a lose statement is followed by the step of playing an audio direction.

Preferably, the step of playing an audio direction includes playing an audio sequence of a commentator saying “Oh, try again”.

Preferably, the step of displaying a video sequence before, during or after one or more of the game segments further includes the step of displaying a video sequence which shows a television style advertisement for a reward.

Preferably, the step of playing the television style advertisement includes one or more of the following steps:

(i) displaying moving visual images on the display;

(ii) playing spoken words via the audio sequence player; and

(iii) playing music via the audio sequence player.

Preferably, the music includes commercial music.

Preferably, the commercial music includes music commonly played on commercial radio stations.

Preferably, the advertisement is stored as a compressed MPEG file and wherein the step of playing the advertisement includes the step of decompressing the compressed MPEG file and playing it on the display.

Preferably, the step of displaying a video sequence showing an animated character performing a task includes the step of displaying the character dealing out one or more playing cards.

More preferably, the step of displaying the character dealing out one or more playing cards is accompanied by a “double up” credit doubling opportunity.

Preferably, the game segments include one or more of:

(a) character win game segments;

(b) logo win game segments;

(c) prize win game segments;

(d) jackpot win game segments; or

(e) free game win game segments.

Preferably, the character win game segments include one or more of:

(a) minor character win game segments; or

(b) major character win game segments.

Preferably, the step of displaying the minor character win game segment is followed by the step of displaying a flash and audio segment.

Preferably, the step of displaying the major character win game segment is followed by the steps of:

(a) displaying a flash-and-character-audio segment; and

(b) displaying the character making a win statement.

Preferably, the logo win game segments include one or more of:

(a) minor logo win game segments; or

(b) major logo win game segments.

Preferably, the step of displaying the minor logo win game segment is followed by the step of displaying a flash-and-advertisement-audio segment.

Preferably, the step of displaying the major logo win game segment is followed by the step of displaying a video sequence which shows a television style advertisement for a reward.

Preferably, the step of displaying the prize vin game segment is followed by the steps of:

(a) displaying a television style advertisement for a prize; and

(b) displaying one of the characters in an animated win-or-lose reward shot sequence.

Preferably, the step of displaying the jackpot win game segment is followed by the step of displaying one or more of the characters in the special feature sequence.

Preferably, the special feature sequence includes a series of special feature sequences and wherein each time a jackpot win game segment is displayed, one of the series of special feature sequences is displayed.

Preferably, the series of special feature sequences are numbered.

Preferably, the credit value of each jackpot win game segment increases as the number of the special feature sequence increases.

Preferably, the series of special feature sequences includes a first special feature sequence and a last special feature sequence.

Preferably, once the last special feature sequence is displayed, the next time he step of displaying the jackpot win game segments is performed, the first special feature sequence is displayed.

Preferably, the series of special feature sequences is played in a recurring loop of special feature sequences.

Preferably, when a player stops using the gaming machine, the special feat=sequence loop starts again, ready for the next player.

Preferably, the step of displaying a plurality of game segments on the display includes playing a reward selection game segment on the display.

Preferably, the step of playing the reward selection game segment includes:

(a) showing a plurality of reels on the display in an initial stationary position, each reel having a plurality of fillable shapes thereon, each fillable shape containing an indicia;

(b) showing the reels spinning on the display; and

(c) showing the reels in a final stationary position with the fillable shapes on each reel substantially spatially aligned with the fillable shapes on the other reels.

Preferably, the indicia include one or more of:

(i) an animated character's face;

(ii) a prize indicia; or

(iii) a jackpot indicia.

Preferably, the step of displaying the minor character win game segments includes showing the reels in the final stationary position with between two and four of a particular animated character's face spatially aligned with one another.

Preferably, the step of displaying the major character win game segments includes showing the reels in the final stationary position with five of a particular animated character's face spatially aligned with one another.

Preferably, the step of displaying the minor logo win game segments includes showing the reels in the final stationary position with between two and four of a particular prize indicia spatially aligned with one another.

Preferably, the step of displaying the major logo win game segments includes showing the reels in the final stationary position with five of a particular prize indicia spatially aligned with one another.

Preferably, the step of displaying the prize win game segments includes showing the reels in the final stationary position with three of a particular prize indicia scattered over the display.

Alternatively, the step of displaying the prize win game segments includes showing the reels in the final stationary position with four of a particular prize indicia scattered over the display.

Alternatively, the step of displaying the prize win game segments includes showing the reels in the final stationary position with five of a particular prize indicia scattered over the display.

Preferably, the step of displaying the jackpot win game segments includes showing the reels in the final stationary position with five of the jackpot indicia scattered over the display.

Preferably, the step of displaying the free game win game segment is followed by the step of displaying a money waterfall, followed by a series of free game segments.

Preferably, the fillable shapes containing indicia are reel images.

Preferably, the prize indicia include the corporate logos or trade marks of one or more of:

(a) manufacturers of products;

(b) suppliers of products; or

(c) service providers.

Preferably, the step of displaying one of the characters in an animated win-or-lose reward shot sequence includes, if the win-or-lose result is a win result, the steps of

(i) displaying video footage of a fireworks display on the display; and

(ii) intermittently superimposing over at least part of that video footage indicia corresponding to the prize which the user has won.

Preferably, the method further includes the additional step of simultaneously playing an audio recording of a fireworks display via the audio sequence player.

Preferably, the gaming machine includes a ticket dispenser for dispensing printed tickets and wherein the step of displaying one of the characters in an animated win-or-lose reward shot sequence is followed by the further steps of dispensing a printed ticket having win-or-lose result indicia printed on it.

Preferably, the printed ticket has three sections.

Preferably, the three-section printed ticket has:

(i) a second chance prize draw section including a blank name and address field;

(ii) a user-retainable prize section having win-or-lose result indicia printed on it; and

(ii) a vendor-retainable prize section having win-or-lose result indicia printed on it.

Preferably, the step of simultaneously playing an audio recording of a fireworks display via the audio sequence player is followed by the additional step of playing an audible directive to remove the printed ticket from the ticket dispenser.

Preferably, the step of playing an audible directive to remove the printed ticket from the ticket dispenser includes playing an audio sequence of a commentator saying “Congratulations, remove your prize ticket from the machine.”

Preferably, the step of displaying the video sequence showing an animated character doing one or more of:

(i) performing a task;

(ii) interacting with another animated character; or

(iii) interacting with a user

includes the step of displaying a promotional sign in relation to the animated character.

Preferably, the character is displayed in front of a three dimensional background, wherein the character is wearing clothing, wherein the character has a hand and wherein the step of displaying the promotional sign in relation to the animated character includes one or more of:

(a) displaying the promotional sign on a poster in the background;

(b) displaying the promotional sign on an animated display in the background;

(c) displaying the promotional sign on the character's clothing; or

(d) displaying the promotional sign on an object in the character's hand.

Preferably, the promotional sign includes the corporate logo or trade mark of one or more of:

(a) a manufacturer of a product;

(b) a supplier of a product; or

(c) a service provider.

Preferably, the character's clothing matches a game theme.

Preferably, the game theme includes one or more of:

(i) a Carribean theme;

(ii) a Chinese theme;

(iii) an African theme;

(iv) an American theme;

(v) an English theme;

(vi) an Italian theme;

(vii) an Australian theme; and

(viii) a Japanese theme.

Preferably, the gaming machine also includes an audio sequence player and wherein the step of displaying the video sequence before, during or after one or more of the game segments wherein the video sequence shows an animated character further includes the step of simultaneously playing an audio sequence to accompany the animated character video sequence.

Preferably, the audio sequence includes commercial music.

Preferably, the commercial music includes music commonly played on commercial radio stations.

Preferably, the gaming machine further includes a controller which controls the displaying of the game segments and the video sequences.

Preferably, the controller is a single board computer.

Preferably, the animated character is one of six possible animated characters.

Preferably, the six possible animated characters include six humanoid characters having bodies resembling human bodies, voices resembling human voices and faces resembling animal faces.

Preferably, the six possible animated characters are three generations of one family, namely an oldest generation, a middle generation and a youngest generation.

Preferably, the oldest generation includes characters known as Pop and Nan.

Preferably, the middle generation includes characters known as Senior and Mrs.

Preferably, the youngest generation includes characters known as Junior and Lizzy.

Preferably, the animated characters are rendered using computer graphics techniques.

Preferably, the method farther includes the steps of:

(a) providing a secondary display proximate the display; and

(b) displaying supplementary information on the secondary display.

Preferably, the supplementary information includes one or more of:

(a) pay structure information;

(b) previous winner clips;

(c) advertising information;

(d) game clips; or

(e) jackpot total information.

Preferably, the secondary display is not controlled by the controller which controls the game on the gaming machine.

According to a second aspect of the invention there is provided a gaming machine for displaying a game, the gaming machine including a display which:

(a) displays a plurality of game segments; and

(b) displays a video sequence before, during or after one or more of the game segments.

Preferably, the video sequence shows an animated character doing one or more of:

(i) interacting with another animated character;

(ii) performing a task; or

(iii) interacting with a user.

Preferably, the display displays the video sequence showing the animated character interacting with the other animated character by displaying the characters in a special feature sequence.

Preferably, the display displays the characters in a special feature sequence by displaying the characters doing one or more of:

(a) acting out a sketch;

(b) telling a joke; or

(c) observing or participating in a sport related situation.

Preferably, the sketch is a situational comedy sketch.

Preferably, the situational comedy sketch includes adult humour.

Preferably, the joke includes adult humour.

Preferably, the display displays the video sequence showing an animated character performing a task by displaying the character in an animated win-or-lose reward shot sequence.

Preferably, the machine displays the character in an animated win-or-lose reward shot sequence by:

(a) displaying the animated character on the display;

(b) displaying the animated character performing a task having a goal which it may succeed or fail at achieving;

(c) identifying the win-or-lose result as a win result if the character succeeds in achieving the goal; and

(d) identifying the win-or-lose result as a lose result if the character fails in achieving the goal.

Preferably, the task is a sport related task.

Preferably, the sport related task includes one or more of:

(i) shooting a basketball towards a basketball hoop, wherein the goal includes getting the basketball through the hoop;

(ii) hitting a golf ball towards a hole, wherein the goal includes getting the golf ball into the hole;

(iii) hitting a snooker ball towards a hole, wherein the goal includes getting the snooker ball into the hole;

(iv) rolling a lawn bowls ball towards a jack, wherein the goal includes getting the ball closest to the jack;

(v) serving a tennis ball, wherein the goal includes serving an ace;

(vi) serving a table tennis ball, wherein the goal includes serving an ace;

(vii) bowling a ten pin bowling ball towards ten pins, wherein the goal includes getting a strike;

(viii) shooting at a clay pigeon target, wherein the goal includes hitting the pigeon;

(ix) marlin fishing wherein the goal includes catching the marlin;

(x) diving off a poolside diving board, wherein the goal includes receiving a perfect score from the judges;

(xi) waterskiing over a ramp, wherein the goal includes landing safely; or

(xii) serving a volleyball, wherein the goal includes serving an ace.

Preferably, the tasks are arranged into themes which determine at least the background and costumes of the animated characters.

Preferably, the themes include one or more of:

(i) a Carribean theme;

(ii) a Chinese theme;

(iii) an African theme;

(iv) an American theme;

(v) an English theme;

(vi) an Italian theme;

(vii) an Australian theme; and

(viii) a Japanese theme.

Preferably, the display displays the video sequence showing the animated character interacting with the user by displaying the character doing one or more of:

(a) making a win statement; or

(b) making a lose statement.

Preferably, the display displays the character making a win statement by displaying the character expressing excitement.

Preferably, the display displays the character making a win statement by displaying the character saying one or more of:

(a) “You beauty”;

(b) “You bloody beauty”;

(c) “Alright”; or

(d) “Ah magic”.

Preferably, each animated character has its own unique win statement.

Preferably, the display displays the character making a lose statement by displaying the character expressing dismay at losing.

Preferably, the display displays the character making a lose statement by displaying the character saying one or more of:

(a) “Damn it”

(b) “That sucks”;

(c) “Get out”; or

(d) “Ah, forget if”.

Preferably, the game machine also includes an audio sequence player and wherein the player plays an audio direction after the display displays the character making a lose statement.

Preferably, the player plays an audio direction by playing an audio sequence of a commentator saying “Oh, try again”.

Preferably, the machine displays a video sequence before, during or after one or more of the game segments by displaying a video sequence which shows a television style advertisement for a reward.

Preferably, the machine plays the television style advertisement by doing one or more:

(i) displaying moving visual images on the display;

(ii) playing spoken words via the audio sequence player; and

(iii) playing music via the audio sequence player.

Preferably, the music includes commercial music.

Preferably, the commercial music includes music commonly played on commercial radio stations.

Preferably, the advertisement is stored as a compressed MPEG file and wherein the machine plays the advertisement by decompressing the compressed MPEG file and displaying its video signals on the display and playing its audio signals via the audio sequence player.

Preferably, the display displays the video sequence showing an animated character performing a task by displaying the character dealing out one or more playing cards.

Preferably, the game segments include one or more of:

(a) character win game segments;

(b) logo win game segments;

(c) prize win game segments;

(d) jackpot win game segments; or

(e) free game win game segments.

Preferably, the character win game segments include one or more of:

(a) minor character win game segments; or

(b) major character win game segments.

Preferably, the machine displays a Bash and audio segment after the minor character win game segment.

Preferably, the display displays:

(a) a flash-and-character-audio segment, and

(b) the character making a win statement;

after displaying the major character win game segments.

Preferably, the logo win game segments include one or more of:

(a) minor logo win game segments; or

(b) major logo win game segments.

Preferably, the display displays a flash-and-advertisement-audio segment after displaying the minor logo win game segment.

Preferably, the display displays a video sequence which shows a television style advertisement for a reward after displaying the major logo win game segment.

Preferably, the display:

(a) displays a television style advertisement for a prize; and

(b) displays one of the characters in an animated win-or-lose reward shot sequence;

after displaying the prize win game segment.

Preferably, the display displays one or more of the characters in the special feature sequence after displaying the jackpot win game segment.

Preferably, the special feature sequence includes a series of special feature sequences and wherein each time the jackpot win game segment is displayed, one of the series of special feature sequences is displayed.

Preferably, the series of special feature sequences are numbered.

Preferably, the credit value of each jackpot win game segment increases as the number of the special feature sequence increases.

Preferably, the series of special feature sequences includes a first special feature sequence and a last special feature sequence.

Preferably, once the last special feature sequence is displayed, the next time the step of displaying the jackpot win game segments is performed, the first special feature sequence is displayed.

Preferably, the series of special feature sequences is played in a recurring loop of special feature sequences.

Preferably, when a player stops using the gaming machine, the special feature sequence loop starts again, ready for the next player.

Preferably, the display displays the plurality of game segments on the display by playing a reward selection game segment on the display.

Preferably, the display displays the reward selection game segment by:

(a) showing a plurality of reels on the display in an initial stationary position, each reel having a plurality of fillable shapes thereon, each fillable shape containing an indicia;

(b) showing the reels spinning on the display; and

(c) showing the reels in a final stationary position with the fillable shapes on each reel substantially spatially aligned with the fillable shapes on the other reels.

Preferably, the indicia include one or more of:

(i) an animated character's face;

(ii) a prize indicia; or

(iii) a jackpot indicia

Preferably, the display displays the minor character win game segments by showing the reels in the final stationary position with between two and four of a particular animated character's face spatially aligned with one another.

Preferably, the display displays the major character win game segments by showing the reels in the final stationary position with five of a particular animated character's face spatially aligned with one another.

Preferably, the display displays the minor logo win game segments by showing the reels in the final stationary position with between two and four of a particular prize indicia spatially aligned with one another.

Preferably, the step of displaying the major logo win game segments includes showing the reels in the final stationary position with five of a particular prize indicia spatially aligned with one another.

Preferably, the display displays the prize win game segments by showing the reels in the final stationary position with three of a particular prize indicia scattered over the display.

Alternatively, the display displays the prize win game segments by showing the reels in the final stationary position with four of a particular prize indicia scattered over the display.

Alternatively, the display displays the prize win game segments by showing the reels in the final stationary position with five of a particular prize indicia scattered over the display.

Preferably, the display displays the jackpot win game segments by showing the reels in the final stationary position with five of the jackpot indicia scattered over the display.

Preferably, the step of displaying the free game win game segment is followed by the step of displaying a money waterfall, followed by a series of free game segments.

Preferably, the fillable shapes containing indicia are reel images.

Preferably, the prize indicia include the corporate logos or trade marks of one or more of:

(a) manufacturers of products;

(b) suppliers of products; or

(c) service providers.

Preferably, the display displays one of the characters in an animated win-or-lose reward shot sequence includes, if the win-or-lose result is a win result, by:

(i) displaying video footage of a fireworks display on the display, and

(ii) intermittently superimposing over at least part of that video footage indicia corresponding to the prize which the user has won.

Preferably, the gaming machine further includes an audio sequence player which simultaneously plays an audio recording of a fireworks display whilst the video footage of the fireworks display appears on the display.

Preferably, the gaming machine includes a ticket dispenser for dispensing printed tickets and wherein the dispenser dispenses a printed ticket having win-or-lose result indicia printed on it after the display displays one of the characters in an animated win-or-lose reward shot sequence.

Preferably, the printed ticket has three sections.

Preferably, the three-section printed ticket has:

(i) a second chance prize draw section including a blank name and address field;

(ii) a user-retainable prize section having win-or-lose result indicia printed on it and

(ii) a vendor-retainable prize section having win-or-lose result indicia printed on it.

Preferably, the audio sequence player plays an audible directive to remove the printed ticket from the ticket dispenser after playing the audio recording of the fireworks display.

Preferably, the audio sequence player plays the audible directive to remove the printed ticket from the ticket dispenser by playing an audio sequence of a commentator saying “Congratulations, remove your prize ticket from the machine.”

Preferably, when the display displays the video sequence showing an animated character doing one or more of:

(i) performing a task;

(ii) interacting with another animated character, or

(iii) interacting with a user;

it also displays a promotional sign in relation to the animated character.

Preferably, the character is displayed in front of a three dimensional background, wherein the character is wearing clothing, wherein the character has a hand and wherein the display displays the promotional sign in relation to the animated character by one or more of:

(a) displaying the promotional sign on a poster in the background;

(b) displaying the promotional sign on an animated display in the background;

(c) displaying the promotional sign on the character's clothing; or

(d) displaying the promotional sign on an object in the character's hand.

Preferably, the promotional sign includes the corporate logo or trade mark of one or more of:

(a) a manufacturer of a product;

(b) a supplier of a product; or

(c) a service provider.

Preferably, the character's clothing matches a game theme.

Preferably, the game theme includes one or more of:

(i) a Carribean theme;

(ii) a Chinese theme;

(iii) an African theme;

(iv) an American theme;

(v) an English theme;

(vi) an Italian theme;

(vii) an Australian theme; and

(viii) a Japanese theme.

Preferably, the gaming machine also includes an audio sequence player and wherein the player plays an audio sequence to accompany the animated character video sequences.

Preferably, the audio sequence includes commercial music.

Preferably, the commercial music includes music commonly played on commercial radio stations.

Preferably, the gaming machine further includes a controller which controls the displaying of the game segments and the video sequences.

Preferably, the controller is a single board computer.

Preferably, the animated character is one of six possible animated characters.

Preferably, the six possible animated characters include six humanoid characters having bodies resembling human bodies, voices resembling human voices and faces resembling animal faces.

Preferably, the six possible animated characters are three generations of one family, namely an oldest generation, a middle generation and a youngest generation.

Preferably, the oldest generation includes characters known as Pop and Nan.

Preferably, the middle generation includes characters known as Senior and Mrs.

Preferably, the youngest generation includes characters known as Junior and Lizzy.

Preferably, the animated characters are rendered using computer graphics techniques.

Preferably, the gaining machine further includes a secondary display situated proximate the display which displays supplementary information.

Preferably, the supplementary information includes one or more of:

(a) pay structure information;

(b) previous winner clips;

(c) advertising information;

(d) game clips; or

(e) jackpot total information.

Preferably, the secondary display is not controlled by the controller which controls the game on the gaming machine.

According to a third aspect of the present invention there is provided a method of generating advertising revenue using a gaming machine having a display, the method including the steps of:

(a) displaying a plurality of game segments on the display;

(b) displaying a video sequence before, during or after one or more of the game segments, wherein the video sequence includes advertising information provided by an advertiser; and

(c) receiving revenue from the advertiser in return for displaying their advertising information on the gaming machine.

Preferably, the advertising information includes one or more of:

(a) television style commercials;

(b) slide show style commercials; and

(c) subliminal advertising information.

Preferably, the subliminal advertising information includes advertising information displayed on the display in or on one or more of:

(a) an animated character's clothing;

(b) an animated character's hand;

(c) a poster in the background of a scene;

(d) an animated display in the background of a scene; or

(e) another object in the background of a scene.

According to a fourth aspect of the invention there is provided a gaming machine including:

a housing;

an actuator mounted to the housing for allowing a gamer to play a game, the actuator being responsive to manual input from the gamer for providing input signals;

a display mounted to the housing for operating selectively in a game mode for displaying the progress of the game to the gamer and an idle mode for displaying other information;

a controller contained within the housing and being responsive to the input signals for driving the display, wherein following an absence of input signals for a predetermined period, the controller drives the display in the idle mode.

Preferably, in the idle mode the display provides visual or audible promotion of the game. In other embodiments, in the idle mode the display provides visual or audible promotion of a product and/or service of an advertiser.

Preferably also, the machine keeps a record of the quantum of gaming credits that the gamer has accumulated, and the controller is responsive to that record for driving the display in the idle mode only if the quantum is zero.

In a preferred form, the machine is contained within a network, and the controller communicates with the network to provide display data indicative of the when the display was driven in the idle mode and the promotion that was displayed. More preferably, the fee paid by the advertiser for the promotion is dependent upon the display data.

According to a fifth aspect of the invention there is provided a method of operating a gaming machine, the method including:

providing a housing;

mounting an actuator mounted to the housing for allowing a gamer to play a game, the actuator being responsive to manual input from the gamer for providing input signals;

mounting a display mounted to the housing for operating selectively in a game mode for displaying the progress of the game to the gamer and an idle mode for displaying other information;

utilising a controller contained within the housing to be responsive to the input signals for driving the display, wherein following an absence of input signals for a predetermined period, the controller drives the display in the idle mode.

According to a sixth aspect of the invention there is provided a gaining machine for allowing a gamer to play a game that provides the gamer with a finite chance of winning awarded gaming credits, the machine including:

a housing;

a register for storing gaming credits that are available to the gamer;

an actuator mounted to the housing for allowing the gamer to play the game, the actuator being responsive to manual input from the gamer for providing input signals;

a display mounted to the housing for displaying the progress of the game to the gamer;

a controller contained within the housing and being responsive to the input signals and the register for driving the display wherein, following a predetermined win of the game by the gamer, the register is progressively increased by the awarded credits while the controller simultaneously drives the display to display to the gamer a video sequence.

Preferably, the game includes a plurality of virtual reels that each bear a plurality of characters. More preferably, the win corresponds to two or more of the same character on different reels being displayed in a given spatial relationship on the display. Even more preferably, the same character on the different reels is also the subject of the video sequence. That is, there is continuity of the character between the win sequence on the virtual reels and the video sequence that is provided during the updating of the register.

Preferably also, the video sequence includes an audio component such that the gamer perceives that the character is talking to the gamer. More preferably, the character congratulates the gamer on the award of the credits. Even more preferably, the audio component includes a music sequence, wherein this music sequence is used consistently with the given character. That is, if there are six characters used in the game, there are six distinct music sequences that are used only in conjunction with a video sequence for the corresponding character.

In a preferred form, the machine provides audio instructions to the gamer to assist the progression of the game.

According to a seventh aspect of the invention there is provided a gaming machine including:

a housing;

an actuator mounted to the housing for allowing a gamer to play a game, the actuator being responsive to manual input from the gamer for providing input signals;

a display mounted to the housing for displaying the progress of the game to the gamer;

a controller contained within the housing and being responsive to the input signals for driving the display such that for predetermined outcomes of the game the display provides the gamer with visual and/or audible instructions as to how to progress the game.

Preferably, the display provides the gamer with visual and audible instructions. More preferably, the game includes a plurality of distinct characters that are selectively animated on the display to provide the instructions. More preferably, the instructions are presented “in character” by that character, in that the gainer perceives the instructions to be coming from that character and not one of the other characters.

According to an eighth aspect of the invention there is provided a method of gaming including:

allowing a gamer to play a game by providing manual input signals;

providing a display for displaying the progress of the game to the gamer;

being responsive to the input signals for driving the display such that for predetermined outcomes of the game the display provides the gamer with visual and/or audible instructions as to how to progress the game.

According to a ninth aspect of the invention there is provided a gaming machine for allowing a gamer to play a succession of games of chance that are based upon a plurality of characters, the machine including:

a housing;

an actuator mounted to the housing for allowing the gamer to play the game, the actuator being responsive to manual input from the gamer for providing input signals;

a display mounted to the housing for operating in a first mode for displaying to the gamer the progress of the present game in the succession of games and a second mode for displaying to the gamer an animated sequence of one or more of the characters;

a controller contained within the housing and being responsive to the input signals for driving the display such that the first mode is interspersed with the second mode and the successively displayed animated sequences include continuity.

Preferably, the continuity of the successively displayed animated sequences is in respect of an underlying story line that is being followed by the characters. More preferably, the underlying story line is a situational comedy. In other embodiments, however, the underlying story line is a fictional drama. In further embodiments, the underlying story line provides updates of predetermined events, where those updates are provided by one or more of the relevant characters.

In a preferred form, the animated sequences are associated with respective feature games that provide the gamer with finite chances of winning a prize. More preferably, the successive feature games include prizes of progressively increasing value. More preferably, the machine includes a register for storing game credits that are accumulated in that machine by the gamer and the prizes are other than additional game credits. Even more preferably, the prizes are goods and/or services of an advertiser and the animated sequence includes promotional information from that advertiser.

According to a tenth aspect of the invention there is provided a method for allowing a gamer to play a succession of games of chance that are based upon a plurality of characters, the method including:

allowing a gamer to play a game by providing manual input signals;

operating a display in a first mode for displaying to the gamer the progress of the present game in the succession of games and a second mode for displaying to the gamer an animated sequence of one or more of the characters;

being responsive to the input signals for driving the display such that the first mode is interspersed with the second mode and the successively displayed animated sequences include continuity.

### BRIEF DESCRITPTION OF THE DRAWINGS

A preferred embodiment of the invention will now be described, by way of example only, with reference to the accompanying drawings in which:

FIG. 1a is a perspective view of a gaming machine according to the invention;

FIG. 1b is a front view of the gaming machine:

FIG. 1c is a top view of the gaming, machine;

FIG. 1d is a perspective view of the gaming machine with its door in an open position;

FIG. 2 is a flow chart illustrating the steps involved in the preferred method of the invention;

FIG. 3 is a screen dump of a double up sequence showing the animated character known as Pop;

FIG. 4 is a screen dump of a double up sequence showing the animated character known as Nan;

FIG. 5 is a screen dump of a double up sequence showing the animated character known as Senior;

FIG. 6 is a screen dump of a double up sequence showing the animated character known as Mrs;

FIGS. 7 is a screen dump of a double up sequence showing the animated character known as Junior;

FIG. 8 is a screen dump of a double up sequence showing the animated character known as Lizzy;

FIG. 9 is a table summarising the preferred combinations of game segments and video sequences;

FIG. 10 is a screen dump of the display showing the different reel images of the preferred embodiment;

FIG. 11 is a screen dump of the display showing the character Pop in a horizontally aligned minor character win game segment;

FIG. 12 is a screen dump of the display showing the character Senior in a horizontally aligned minor character win game segment;

FIG. 13 is a screen dump of the display showing the character Lizzy in a diagonally aligned minor character win game segment;

FIG. 14 is a screen dump of the display showing the character Junior in a diagonally aligned minor character win game segment;

FIG. 15 is a screen dump of the display showing an example of a multiple win minor character win game segment;

FIG. 16 is a screen dump of the display showing the character Pop in a horizontally aligned major character win game segment;

FIG. 17 is a screen dump of the display showing the character Pop making his win statement,

FIG. 18 is a screen dump of the display showing the character Junior in a horizontally aligned major character win game segment;

FIG. 19 is a screen dump of the display showing the character Junior making his win statement,

FIG. 20 is a screen dump of the display showing three Pepsi logos aligned in the middle row of reels in a minor logo win game segment;

FIG. 21 is a screen dump of the display showing five Pepsi logos aligned in the middle row of reels in a major logo win game segment;

FIG. 22 is a screen dump of the display showing part of a Pepsi commercial displayed in the reel area;

FIG. 23 is a screen dump of the display showing a prize win game segment in which reel images of the Pepsi logo are scattered over the display;

FIG. 24 is a screen dump of the display showing a movie style clipboard being displayed which precedes the display of one of the characters in an animated win or lose reward shot sequence;

FIG. 25 is a screen dump of the display showing the character junior involved in the sport related task of shooting a basketball towards a basketball hoop;

FIG. 26 is a screen dump of the display showing the character Pop hitting a golf ball towards a hole;

FIG. 27 is a screen dump of the display showing the identification of a win result if the character succeeds in its prize shot;

FIG. 28 is a block diagram of a sample prize ticket;

FIG. 29 is a screen dump of the display showing a jackpot win game segment;

FIGS. 30 and 31 are screen dumps of the display showing a film like countdown which prepares the player for the special feature;

FIGS. 32 is a screen dump of the display showing the clip board which precedes the first special feature sequence;

FIG. 33 is a screen dump of the display showing the first special feature sequence in the Chinese theme game;

FIGS. 34 and 35 are screen dumps of the display showing a film like countdown which prepares the player for the sixth special feature sequence;

FIG. 36 is a screen dump of the display showing episode 6 of the special feature sequences;

FIG. 37 is a screen dump of the display showing the identification of a jackpot win result;

FIG. 38 is a screen dump of the display showing a free game win game segment;

FIG. 39 is a screen dump of the display showing the money waterfall which follows the free game win game segment; and

FIGS. 40 to 49 are respective screen dumps of the display showing the progression of the game in a second embodiment where a win line includes two to four like characters;

FIGS. 50 to 57 are respective screen dumps of the display showing the progression of the game similarly to FIGS. 40 to 49, although with multiple win lines;

FIGS. 58 to 65 are respective screen dumps of the display showing the progression of the game where a win line includes the maximum of five like characters;

FIGS. 66 to 77 are respective screen dumps of the display showing the progression of the game for a win line that includes a product or service of an advertiser that is being promoted;

FIGS. 78 to 90 are respective screen dumps of the display showing the progression of the game where a feature game is initiated and a character based video sequence is displayed; and

FIGS. 91 to 94 are respective screen dumps of the display showing the progression of the game where a win line includes the award of free games.

### DESCRIPTION OF THE PREFFERED MODES

The preferred embodiment of the present invention is able to provide the user with a much more entertaining game than those currently known. This is achieved in a number of ways.

Firstly, after particular game segments are displayed a special feature sequence is played in which animated characters interact with one another in a situational comedy situation. Such sequences not only entertain the user, but they may also reduce the amount of money which the user spends on the gaming machine in a given time period. This is because, instead of placing additional bets, they are watching the special feature sequence.

The second advantage of the special feature sequence is that the credits awarded while the sequence is shown increases in proportion to the number of the special feature sequence being shown. For example, the credit value of the game segment which results in the first special feature sequence is 200 credits, the credit value of the game segment which results in the second special feature sequence is 300 credits, and so on. When the user gets to the sixth special feature sequence, they are issued a printed ticket which enables them to enter a jackpot prize draw to win a significant prize, such as a house, one million dollars, or the like. Thus the special feature sequences not only entertain the user, but they also encourage the user to keep playing because they know they are getting closer to the final sequence and therefore the final jackpot.

Thirdly, the preferred embodiment of the present invention also enables a user to win prizes, rather than just credits. Once the prizes are won a printed ticket is dispensed which allows the user to claim that prize. In addition, during the awarding of the prize a prize shot sequence is played. This is an additional entertaining feature in which one of the animated characters is involved in a sport related task which they can either fail or succeed at achieving. Before the prize shot is played, a television style advertisement for the prize is also played. The television style advertisement involves displaying moving visual images on the display, playing spoken words via the audio sequence player and playing music via the audio sequence player. The music is commercial music commonly played on commercial radio stations. The advertisement is stored as a compressed MPEG file which is played by decompressing the file and playing it on the display. In this way product manufacturers and service providers are able to advertise their goods and services on the gaming machine whilst entertaining the user. In addition, the awarding of a prize can be done separately from the awarding of credits, so that the prize shots do not affect the cash percentage figures.

The present embodiments also encompass a number of other advertising advantages. Not only are the logos of particular products or services pictured on the reel images and in the television style advertisements for those products, more subtle advertising is also achieved in the background of the special feature sequences and prize shot sequences. In this way, advertising revenue can be generated by showing a particular logo in the background of a sequence, or on the clothing of a character, or in a product in their hand.

In this way, the present embodiment is able to not only provide superior entertainment value for the gamer, but is also able to encourage them to continue playing for longer, and provides a means for advertisers to advertise their products.

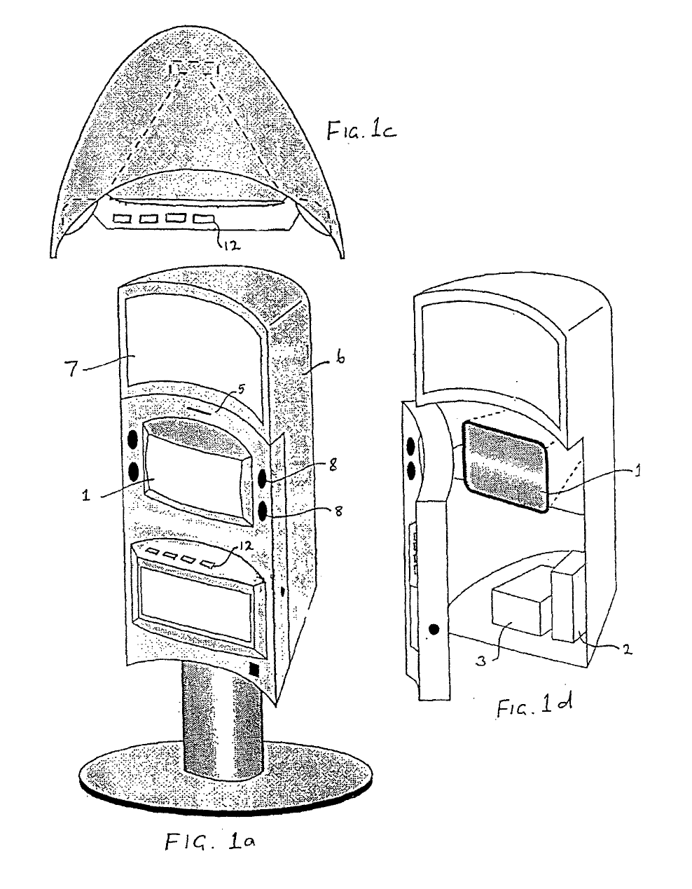

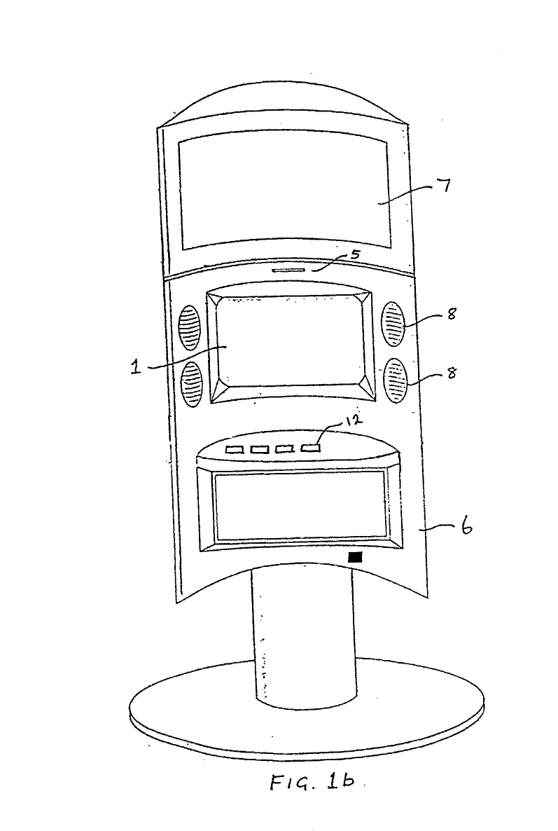

Referring to the drawings, FIGS. 1a-1d show a gaming machine including a display 1, an audio sequence player 2, a controller 3, and a ticket dispenser 5. Additional features of the preferred gaming machine include an aesthetically designed casing 6, a secondary display 7 and a number of speakers 8. Alternative styles of gaming machine casing are also envisaged.

FIG. 2 shows a flow chart illustrating the steps involved in displaying a game on a gaming machine according to the preferred method. As shown in FIG. 2 the preferred method involves displaying a number of game segments on the display and displaying a video sequence before, during or after one of the game segments. The video sequence shows an animated character interacting with another animated character, performing a task or interacting with a user.

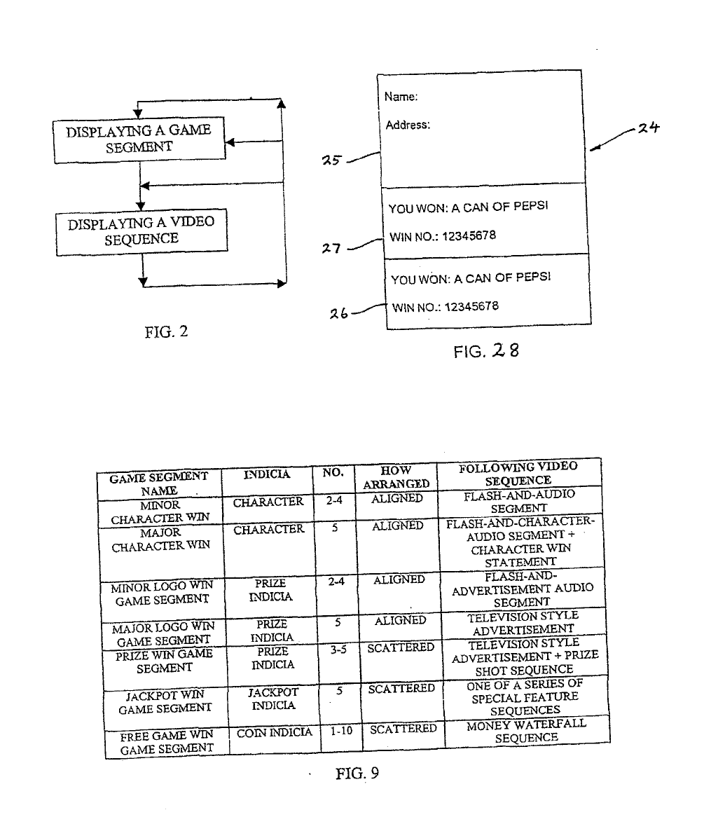

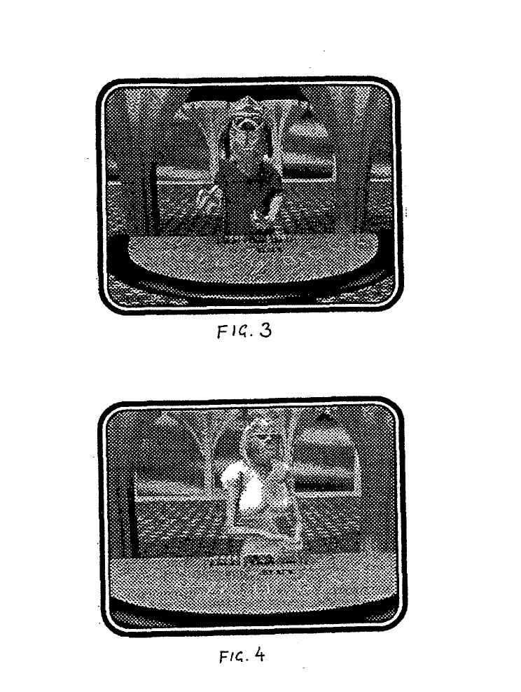

There are six animated characters and they are rendered using computer graphics techniques. The six animated characters are humanoid characters which have bodies resembling human bodies, voices resembling human voices and faces resembling animal faces. They are three generations of one family, namely an oldest generation, a middle generation and a youngest generation. The oldest generation characters are known as Pop and Nan. The middle generation characters are known as Senior and Mrs and the youngest generation characters are known as Junior and Lizzy. Pop, Nan, Senior, Mrs, Junior and Lizzy are shown in FIGS. 3, 4, 5, 6, 7 and 8 respectively. Each of the animated characters has a unique character voice and theme tune.

In other embodiment use is made of a different number and type of characters. Moreover, a number of different combinations of game segments and video sequences are envisaged. Preferred combinations are summarised in the table of FIG. 9.

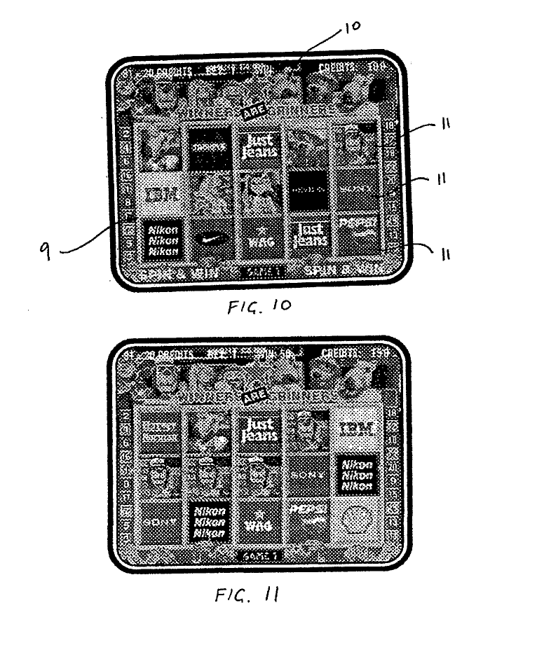

Displaying the game segments on the display involves playing a reward selection game segment on the display. A number of different types of reward selection game segments are available. In its preferred form, the reward selection game segment involves showing three rows of five reel images on the display in an initially stationary position. As shown in FIG. 10 each of the reel images 11 is either one of the animated character's faces, some sort of prize indicia or a jackpot indicia. The reel images 11 appear in a reel area 9 on the display, surrounded by a border 10. The border shows the six animated characters wearing clothing that matches the particular game theme. The prize indicia are the corporate logos or trade marks of product manufacturers, product suppliers or service providers. They not only indicate the prize which a user can play but they also serve to advertise that product or service.

The trade marks shown in the drawings are for the purposes of illustration only and should not be taken to imply any relationship between the present inventor or assignee and the owners of the respective marks.

Having shown the reel images in a stationary position, the reward selection game segment then involves showing the reel images spinning on the display in the traditional fashion and then showing the reels in a final stationary position. In the different reward selection game segments, the reel images are aligned or misaligned with each other in a number of different ways.

As seen in FIG. 10, in a losing reward selection game segment, the reel images do not align in any particular pattern and the user is awarded no credits.

A number of different winning combinations are provided, each followed by an appropriate audio or video sequence. Details of these particular combinations are summarised in FIG. 9 and are explained in detail below. It will be appreciated by a person skilled in the art, from the teaching herein, that other winning combinations are possible.

Displaying the minor character win game segment involves showing the reels in their final stationary position with between two and four of a particular animated characters face spacially aligned with one another. Examples of minor character win game segments with the characters aligned horizontally are shown in FIGS. 11 and 12. Examples of minor character win game segments with the characters aligned diagonally are shown in FIGS. 13 and 14. An example of a multiple win minor character win game segment is shown in FIG. 15. Once that game segment has been played, a flash-and-audio segment is played. This involves flashing the reel images which have the aligned character faces on them and playing a short audio grab of a piece of commercial music corresponding to that particular character. Each of the characters has their own piece of commercial music that is played in either the foreground or background when that character appears. In the flash-and-audio segment, the character's personal music is only played for a few seconds, whilst the reel images are flashing. In the multiple win scenario, the flash-and-audio segments are played sequentially, beginning from the highest to lowest payout.

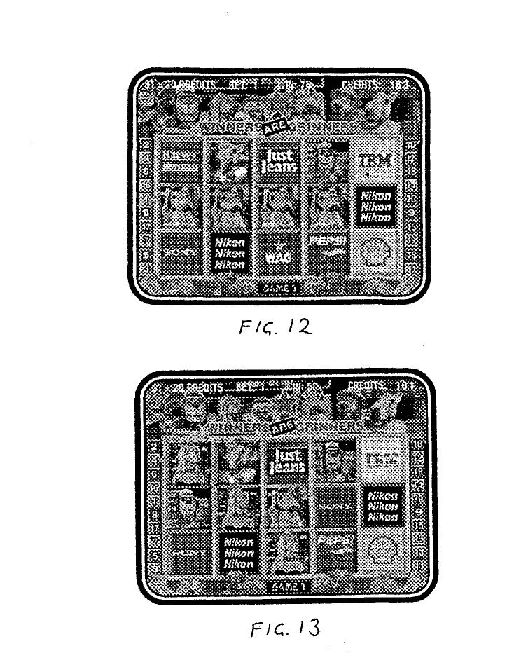

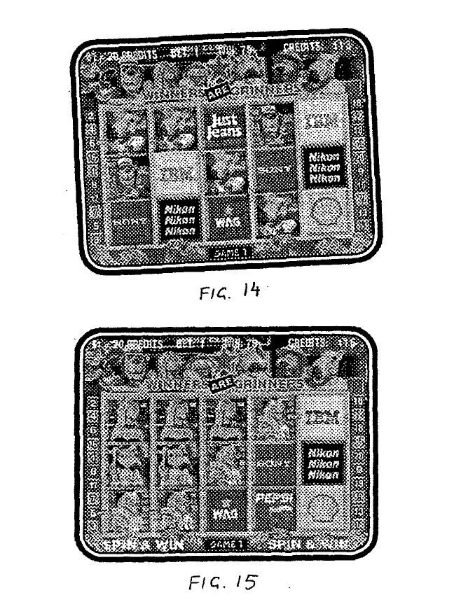

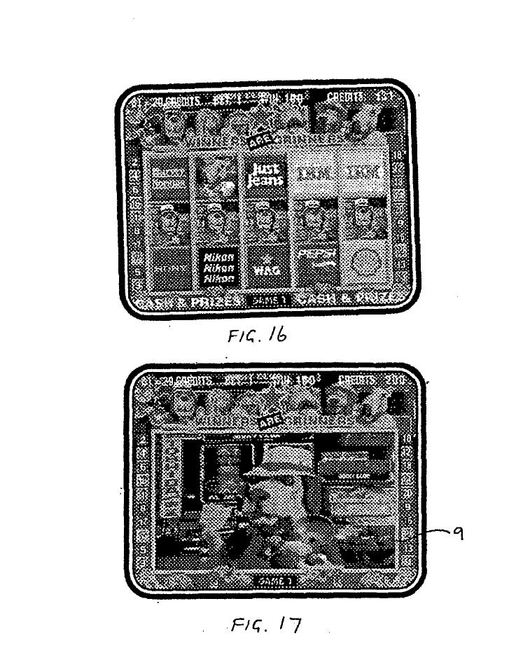

As shown in FIG. 16 the step of displaying the major character win game segment involves showing the reels in a final stationary position with five of a particular animated character's face spacially aligned with one another. In this example, the character Pop is shown on five aligned reel images. When this happens a flash-and-character-audio segment is played, followed by a video sequence displaying the character making his or her win statement. The flash-and-character-audio segment involves flashing the five aligned character face reel images, whilst playing that character's theme tune. In this example, Pop's theme tune is the song “Cheek to cheek”. As shown in FIG. 17, when displaying the character making his or her win statement, the whole of the reel area 9 is replaced by a video segment showing the character expressing excitement. Each different character has a different win statement such as “You beauty”, “You bloody beauty”, “Alright” or “Ahh magic”. Other character win statements are also envisaged. Whilst the character is displayed on the screen making his or her personal win statement, their theme tune is played in the background.

Once the character has been displayed making a win segment, the user has the option to double up their credits by pressing the double up button 12, most clearly shown in FIG. 1a. If they choose that option, then the character whose face appeared in the winning reels is shown in animated sequence dealing out cards in order to see whether the user guesses black or red correctly. Such double up sequences are shown in FIGS. 3 to 8. Alternative arrangements of double up animated sequences are also envisaged.

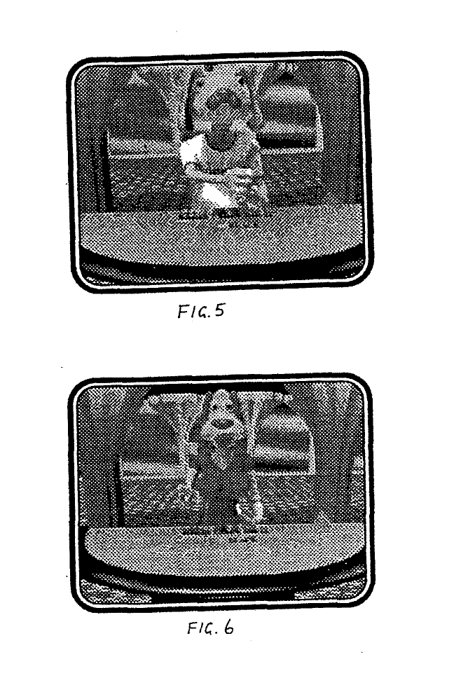

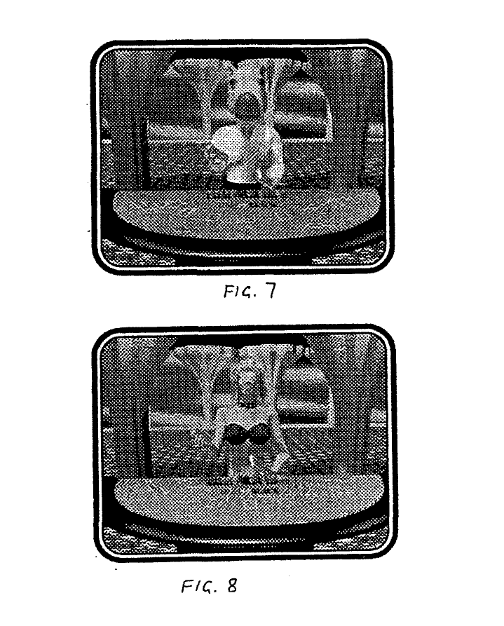

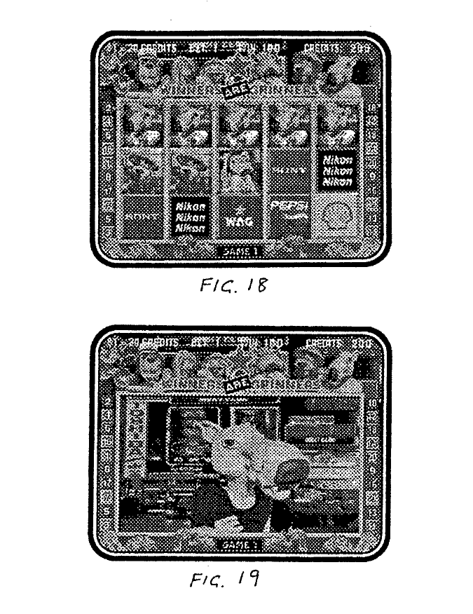

The major character win game segment involving Junior is shown in FIG. 18. A screen dump of Junior making his win statement is shown in FIG. 19 and his corresponding double up sequence is shown in FIG. 7.

As shown in FIG. 20, the step of displaying a minor logo win game segment involves showing the reels in a final stationary position with between two and four of a particular prize indicia spacially aligned with one another. In this example there are three Pepsi logos aligned in the middle row of reels. Following this game segment, a flash and advertisement audio segment is displayed. In this video sequence, the aligned winning reel images flash whilst the soundtrack for a short commercial grab is played which advertises the particular prize. In the minor logo win game segment shown in FIG. 20 the audio grab part is part of a commercial for Pepsi.

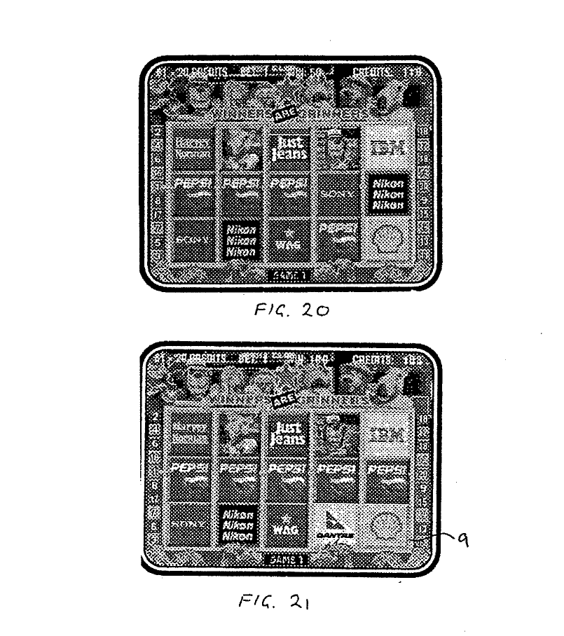

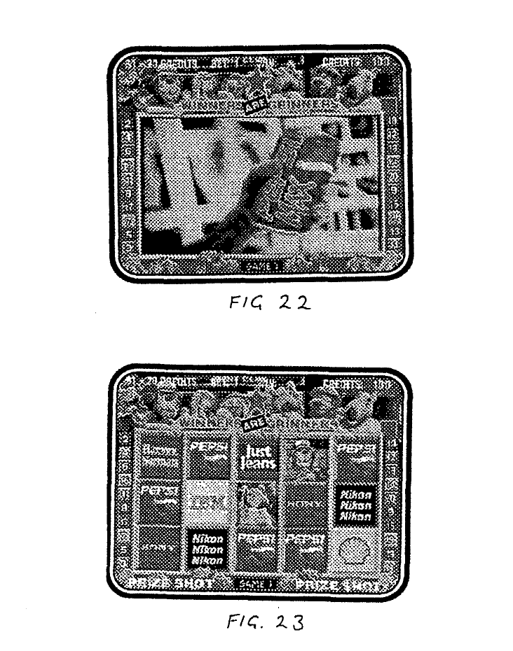

As shown in FIG. 21, the step of displaying the major logo win game segment involves showing the reels in a final stationary position with five of a particular prize indicia spacially aligned with one another there are five Pepsi logos aligned in the middle row of reels. After this game segment is displayed, a television style advertisement for the particular prize is displayed in the reel area 9 of the screen. FIG. 22 shows a screen dump of part of a Pepsi commercial displayed in the reel area. This commercial is a television style advertisement which is accompanied by appropriate audio sequences.

A shown in FIG. 23, the step of displaying a prize win game segment involves avowing the reels in a final stationary position with either three, four or five of a particular prize indicia scattered over the display. In this example, there are 5 reel images with the Pepsi logo on them scattered over the display. Because the prize indicia are scattered over the display, and not aligned with each other, the present invention allows gaming machines to offer actual prizes to the users, rather than just credits, without affecting the cash percentage figures which gaming venues are legally obligated to guarantee.

Once this game segment has been displayed the following video sequence involves displaying a television style advertisement for the prize and displaying one of the characters in an animated win or lose reward shot sequence. The television style advertisement for this prize is substantially the same as that described above with reference to FIG. 22.

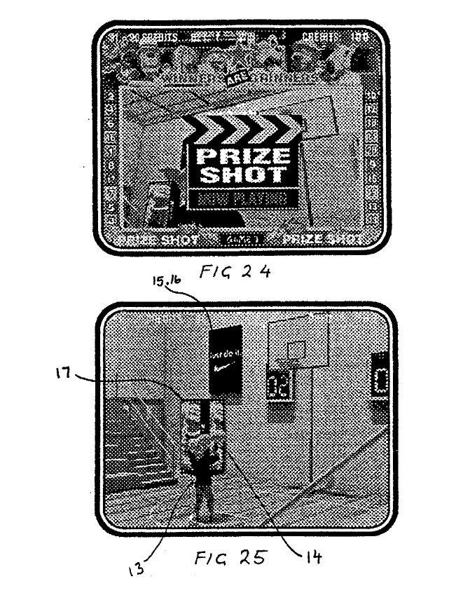

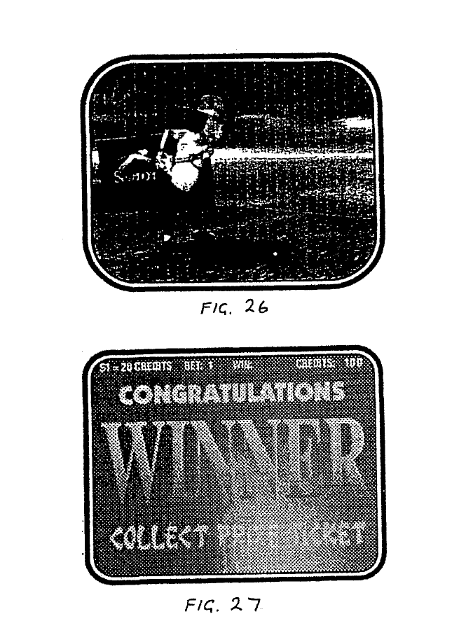

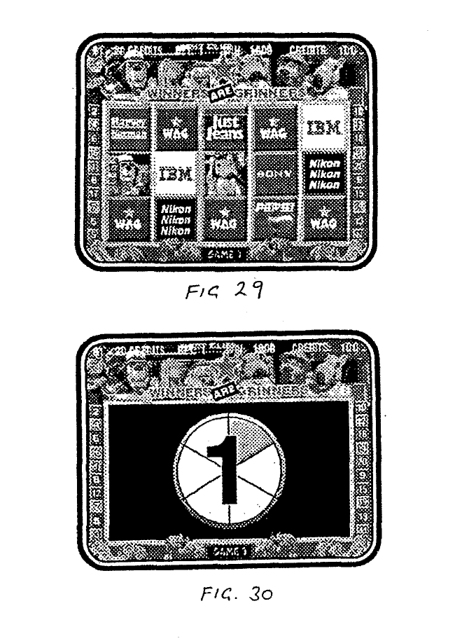

As shown in FIG. 24, the step of displaying one of the characters in an animated win or lose reward shot sequence begins with a movie style clipboard being displayed on the screen. As shown in FIGS. 25 and 26, the sequence then involves displaying a full screen video sequence of one of the animated characters performing a task having a goal which the character may succeed or fail at achieving. As shown in FIG. 27, the sequence then identifies the win or lose result as a win result if the character succeeds, or a lose result if the character fails. FIG. 25 shows the character junior involved in a sport related task of shooting a basketball towards a basketball hoop. In that scenario the goal involves getting the basketball through the hoop. In this preferred embodiment, each of the different characters has a particular sport related task which is their prize shot. For example, FIG. 26 shows the character Pop hitting a golf ball towards a bole, in which the goal involves getting the golf ball into the hole. A number of different sport related tasks are also envisaged such as:

(a) hitting a snooker ball towards a hole, wherein the goal involves getting the snooker ball into the hole;

(b) rolling a lawn bowls ball toward a jack, in which the goal involves getting the ball closest to the jack;

(c) serving a tennis ball, in which the goal involves serving an ace;

(d) serving a table tennis ball, in which the goal involves serving an ace;

(e) bowling a ten pin bowling ball towards ten pins, in which the goal involves getting a strike;

(f) shooting at a clay pigeon target, in which the goal involves hitting the pigeon;

(g) marlin fishing, in which the goal involves catching the marlin;

(h) diving off a poolside diving board, in which the goal involves receiving a perfect score from the judges;

(i) waterskiing over a ramp, in which the goal involves landing safely; or

(j) serving a volley ball in which the goal involves serving an ace.

A number of other different sport related prize shot tasks are also envisaged. Each character has their own unique prize shot for each game theme. For example, Junior may have a basketball prize shot as his sequence in the American theme, whereas he might have the waterskiing over a ramp sequence in the Caribbean theme. Similar comments apply to each of the other characters. The different themes include a Carribean theme, a Chinese theme, an African theme, an American theme, an English theme, an Italian theme, an Australian theme and a Japanese theme. Additional themes are also envisaged.

As can be seen in FIG. 25, during the prize shot sequences, and in the special feature sequences explained below, the character is displayed in front of a three dimensional background. The character is wearing clothing 13 and has at least one hand 14. During this prize shot sequence a promotional sign 15 is displayed in relation to the animated character. In this way, advertising revenue can be generated from sponsors who wish to advertise in the background. Looking particularly at FIG. 25 there is a “Nike Just do it” poster 16 in the background along with a Pepsi drink dispenser 17. In addition, the character Junior is wearing Nike clothing. Other means of displaying promotional signs in relation to the characters, such as having the characters holding items, or displaying them on animated displays in the background are discussed below with reference to the special features. Alternative methods of displaying such promotional signs are also envisaged.

In the preferred embodiment the promotional signs involve the corporate logos or trade marks of product manufacturers, product suppliers and/or service providers.

Not only does the prize shot performed by the particular character vary in accordance with the game theme, so too does the characters clothing.

Once the prize shot sequence has been displayed, a win or lose result is identified. As shown in FIG. 19, if the character is successful, the character is displayed making their personal win statement and the win is then identified on the screen. FIG. 27 shows the win being identified on the screen. In that sequence the system displays video footage of a fireworks display and intermittently superimposes over at least part of that video footage, indicia corresponding to the prize which the user has won. In the examples shown in FIGS. 23 through 25, a Pepsi logo would be shown intermittently over the fireworks video footage. At the same time, an audio recording of the fireworks display is played via the audio sequencer and the user is directed to collect their prize ticket. This involves playing an audio sequence of a commentator saying “congratulations, remove your prize ticket from the machine”. The ticket 24 is then dispensed via the ticket dispenser 5, most clearly seen in FIG. 1a.

A sample prize ticket is shown in FIG. 28. The ticket is a printed ticket having win or lose result indicia printed on it. The ticket has three sections being a second chance prize draw section 25 including a blank name and address field, a user-retainable prize section 26 having win or lose result indicia printed on it and a gaming venue retainable prize section 27 having win or lose result indicia printed on it.

On the other hand, if the result of the prize shot was a lose result the system displays the character making a lose statement. This involves displaying the character expressing dismay at losing. Each of the characters has their own unique lose statement such as “Dammit”, “That sucks”, “Get out” or “Ahh forget it”. Alternative lose statements are also envisaged. Once the character has been displayed making the lose statement an audio direction is played. This involves playing an audio sequence of a commentator saying “Oh, try again”.

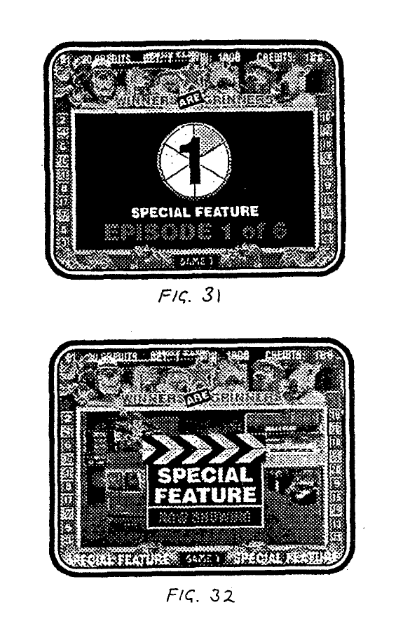

Continuing with the explanation of the different video sequences that follow the particular game segments, the step of displaying the jackpot win game segment involves showing the reels in a final stationary position with five of the jackpot indicia scattered over the display. An example is shown in FIG. 29. The jackpot indicia in this instance is the WAG logo. Once this segment has been played, one or more of the characters are displayed involved in one of a series of six special feature sequences. As shown in FIGS. 30 and 31 the sequence begins with a film like countdown which prepares the player for the special feature. At the same time an audio directive is played which involves a commentator saying “you are now playing special feature one”. This audio directive varies depending on the number of the special feature sequence which the system is up to. Each time the jackpot win game segment is played, the next special feature sequence in the series is played. When the user gets to special feature series number 6 they have a chance of winning the jackpot, details of which are discussed below. For each particular game theme there are six different special feature sequences.

The special feature itself involves at least one of the animated characters interacting with another of the characters. In such a sequence the characters are displayed acting out a sketch, telling a joke or observing or participating in a sport related situation. In the preferred embodiment, the sketch is a situational comedy sketch involving adult humour. Similarly, the joke told by one character to another involves adult humour.

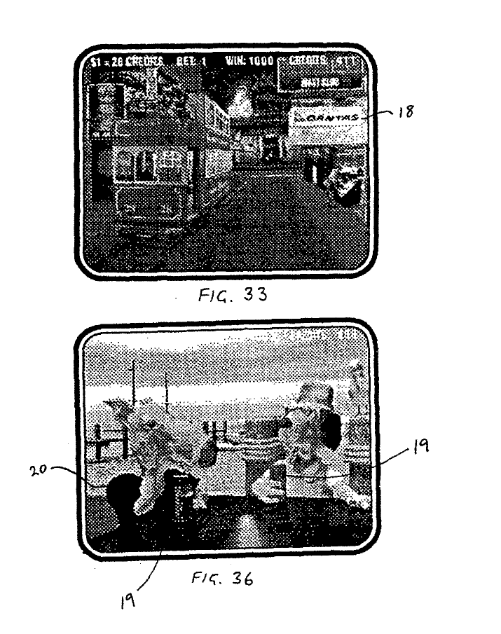

The first special feature sequence in the Chinese theme game is shown in FIGS. 32 and 33. The sequence begins with a clipboard announcing that the special feature is now showing. The special feature then shows a tram travelling down a road with a number of the characters on the top of the tram speaking with one another.

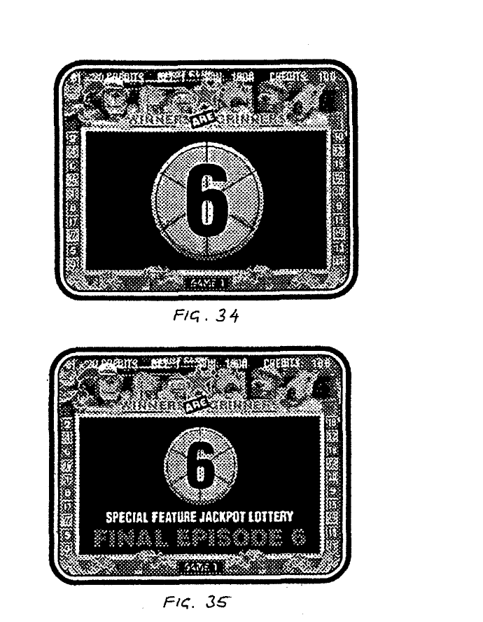

The special feature sequence shown in FIGS. 34 to 36 shows Junior asking Pop for some advice about women. As can be seen in both of those special feature sequences promotional signs are displayed in relation to the animated character. In FIG. 33 a Qantas poster 18 or animated display is shown in the background. In FIG. 36 both characters are holding cans of drink 19 which show corporate logos of particular sponsors. Junior is also wearing a Nike t-shirt 20. In this way, not only are users entertained by the special feature sequences, product manufacturers and service providers are able to advertise their products in the background of those sequences.

In this preferred embodiment, the credit value of each of the jackpot win game segments increases as the number of the special feature sequence increases. Thus, as the special feature sequences approach number 6, the user is encouraged to continue playing the game, as their credits are building and they are approaching the major jackpot at the end.

As shown in FIGS. 34, 35 and 36, when the sixth jackpot win game segment is displayed, episode 6 of the special feature sequences is displayed. As seen in FIG. 37, at the end of the sequence their win is identified on the screen in a similar manner to that which followed the win result in the prize shot sequence. In this case, a fireworks display is shown on the screen with the words “CONGRATULATIONS WINNER COLLECT JACKPOT LOTTERY ENTRY TICKET” superimposed over the fireworks display. At the same time an audio recording of the fireworks display is played via the audio sequencer.

A printed ticket is then dispensed via the ticket dispenser. The ticket is a three part ticket as previously described with reference to FIG. 28, and enables the user to enter the jackpot lottery. Once the user has removed the ticket from the machine, they then give it to a central point at the gaming venue for their chance to win the overall jackpot.

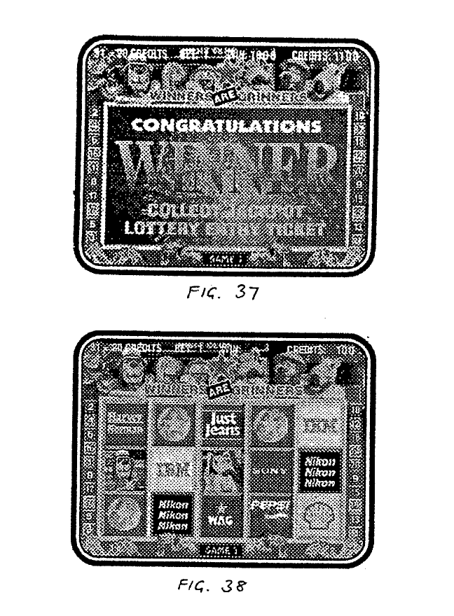

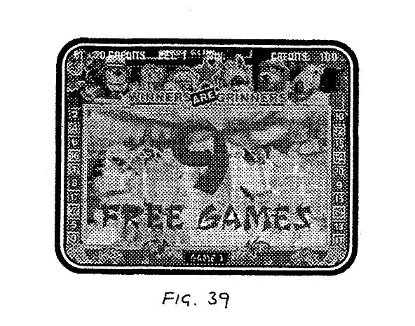

As shown in FIG. 38 the step of displaying the free game win game segment involves showing the reels in a final stationary position with a number of coin reel images scattered over the display. In the preferred embodiment, one coin reel image gives 3 free games, 2 coin reel images gives 6 free games, 3 coin reel images gives 9 free games and so on. The maximum number of free games, for ten coin reel images on the display, is 30. As shown in FIG. 39, once the free game win game segment has been displayed, a money waterfall is displayed accompanied by an audio sequence of the sound of falling coins. Once the money waterfall has been displayed, the user is then presented with a series of free game segments, which do not cost them any credits.

In this preferred embodiment the secondary display 7 shown in FIGS. 1a to 1d is an LCD screen or monitor which is capable of displaying fixed or moving video images. Although it is shown on top of the main display in FIG. 1a, alternative arrangements are also envisaged. The secondary display preferably displays one or more of pay structure information, previous winner clips, advertising information, game clips or jackpot total information. The pay structure information includes information about the credits or prizes awarded for particular combinations of reel images. Prior art arrangements simply have this information printed on paper above the main display. The previous winner clips include video and/or audio clips of people who have previously won on that particular machine, or in that particular gaming venue. The advertising information not only includes advertisements for particular products and services, but also includes advertising information relating to activities in or near the gaming venue. For example, if the gaming venue was a casino, the secondary display may advertise a particular bar or restaurant in that casino, or a performer who might be playing there in the near future. The game clips provide a looping display of the different modes of the game which the user can play on the main display. The jackpot total information is primarily intended for gaming machines which are linked to one another and have an increasing jackpot total associated with them. The secondary display of this preferred embodiment occasionally displays the current total jackpot.

Alternatively, the secondary display 7 may also be a simple light box arrangement.

In this preferred embodiment the controller controls the displaying of the game segments and the video sequences and is a single board computer.

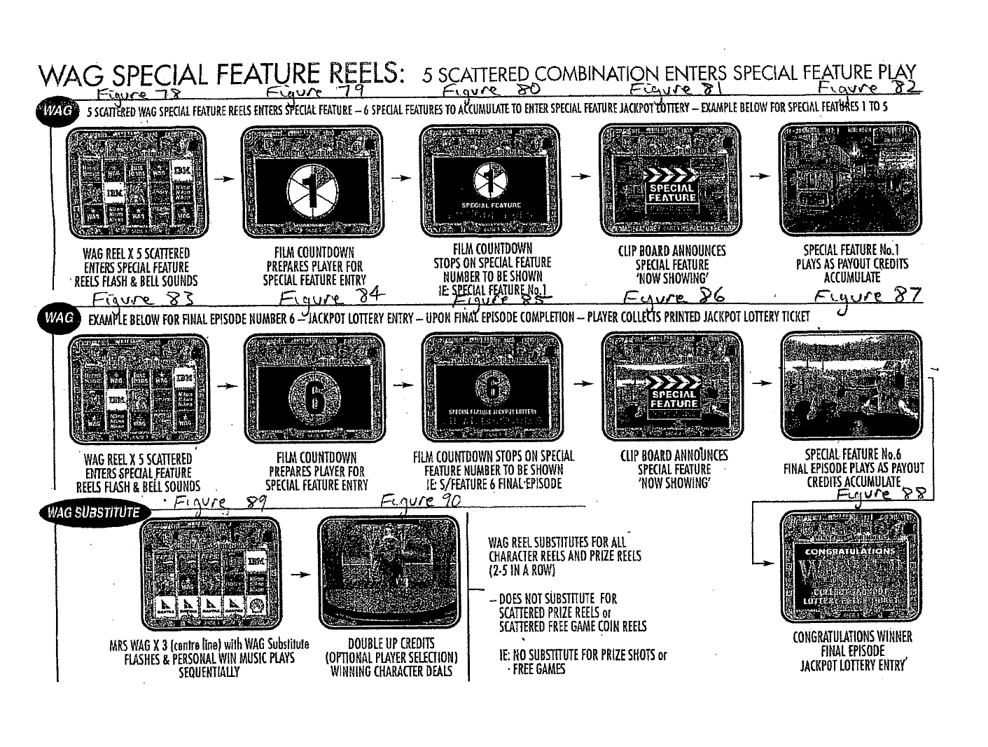

Another embodiment of the invention is illustrated in FIGS. 40 to 94. While some of the detail of this embodiment is different to the first, it is implemented with the same hardware.

In this case, the machine is selectively progressed by controller 3 between a gaming mode and a passive mode. In the gaming mode, which will be described in more detail below, the controller is following the relevant software routines in response to the inputs from the gamer. In the passive mode, controller 3 is driving display 1 to display to those persons in the vicinity visual and/or audible information. At some times, this information is inducing or encouraging the person or persons to play the game, while at other times the information is promoting the goods and/or services of an advertiser. Moreover, controller 3 maintains records of the time and content of any advertisements. These records are passed to the gaming establishment to allow analysis of the frequency of the advertising. In some embodiments, the records are used to determine the fee paid by the advertiser to the establishment.

The machine remains in the passive mode until such time as it is actuated by a gamer. Moreover, after the conclusion of a game by the gamer, the machine will “time out” after a predetermined period and return to the passive mode. In some embodiments, the predetermined period commences once there are no further gaming credits held on the machine.

Once a gamer decides to play the machine, he or she inserts coins into the appropriate slot of inserts a membership card or other information carrier into another slot in the machine. In any case, controller 3 registers the accumulation of gaming credits and progresses from the passive mode to a gaming mode. The first image presented to the gamer upon entry into the gaming mode is shown in FIG. 40. This image includes indicia informing the gamer that the game type to be played is “GAME ONE”. When the gamer has played sufficient successive games included in “GAME ONE” he or she will eventually encounter “GAME TWO” and so on. That is, the terms “GAME ONE”, “GAME TWO” etcetera each encompass a sequence of standard games, a number of prize shot games, a number of “free game” games and a special feature game that concludes the game sequence. Each game includes a corresponding special feature and these, together with the other types of games referred to, will be described in more detail below.

In this embodiment there are six games of these type that are progressively played by the gamer. However, if the gamer leaves the machine, the machine will return to the passive mode. Once activated from that passive mode the image shown in FIG. 40 will again be presented. That is, the machine will default to “GAME ONE”. This provides some encouragement for the gamer to continue playing the machine so that they are able to progress through to the completion of all six games. However, the six games are different, and offer progressively greater rewards. Moreover, the six games include a common story line that is contributed to by the characters to provide the gamer with entertainment other than the gaming itself. Accordingly, as to whether the machine increases or decreases revenues for the establishment is able to be varied according to the balance between the time that the machine is allowing gaming, and the time that the machine is providing other entertainment.

As will be described in more detail below, the games provided in the gaming mode include a succession of games which provide the gamer with a finite chance of winning a variety of prizes. As with prior gaming machine, prizes are in the form of gaming credits that are accumulated by controller 3 and which are redeemable by the gamer either as cash or as additional games. However, this preferred embodiment, similarly to the first embodiment, allows the gamer to also play for prizes in addition to the gaming credits.

The game then progresses to the virtual reels, such as that illustrated in FIG. 41. These reels are displayed to the gamer and allow the gamer to select one or more “lines” of the available lines. It is on these lines that the gamer is speculating that a winning combination of the characters and other icons will occur. The higher the number of lines nominated the greater the credit accumulation is debited. This arrangement of lines and debits is known in the gaming machine field.

The game is actuated by the gamer and allowed to progresses, in that the virtual reels spin at different relative speeds and all stop at in a given time to provide a specific spatial combination of images that include both one or more of the characters and other icons. In the event that no winning combinations are formed along the line or lines that were designated by the gamer, then the gamer is free to either commence another game—contingent upon the availability of the required gaming credit—or to finish the game. If the gamer finishes the game he or she is free to redeem any unused credits. Once those credits are redeemed, if there are no credits remaining, controller 3 commences a “time out” period. Once that period has expired, in that there has not been any gamer activity on the machine during that period, the machine returns to the passive mode.

In the case where a winning combination is formed along the or one of the lines designated by the gamer, then a win sequence is entered. For example, in FIG. 42 a winning combination is formed along the middle line and includes three like images of one of the characters “POP” that are contiguously disposed along that line. The other images do not provide a winning combination and, as is shown, they include other of the characters used in the game as well as icons containing trade marks of advertisers, commercial partners, sponsors or participants in the gaming establishment.

It will be appreciated that while the winning combination is shown with three contiguous like characters, the following description also applies to two or four contiguous like characters.

In this case, the contiguous character images flash and the gamer is provided with an audible tune that is associated with the character concerned. Again, in this example, the character is POP and the consistency of the music with the appearance of POP is to provide the gamer with further sensual input about the operation of the game.

Controller 3 then displays to the gamer a double up option, such as that illustrated in FIG. 43. The gamer is then able to indicate whether or not he or she wishes to gamble the win, which are a predetermined number of gaming credits. If so, the gamer nominates “BLACK” or “RED” to correspond with the colour of the virtual playing card that is to be turned by a visual and audible animation of that same character that was in the winning combination. In this case, POP is animated to progressively present to the gamer the result of the additional gamble. If the gamer is successful he or she is presented with the opportunity to again double up, and so on.

If the gamer chooses not to wager the credits in a double up sequence, or once the gamer decides not to further wager the credits in the double up sequence, those credits are added progressively to the accumulated credits. During that progressive add, the display is presenting to the gamer an animated image of POP who is seen to be congratulating the gamer on the successful wager. That is, the machine provides virtual communication and encouragement to the gamer. In some embodiments the encouragement is also accompanied by the music or sound bite associated with that character.

Similar operations are involved for other winning combinations of like characters. More examples are provided in FIGS. 44 and 45, FIGS. 46 and 47, FIGS. 48 and 49, FIGS. 52 and 53, and FIGS. 54 and 55 respectively.

Where a gamer designates multiple lines and there are winning combinations along more than one of those lines, the gamer is awarded gaming credits for all winning combinations. However, the music, encouragement and double up animations are provided by the character who was the subject of the greatest number of images in the winning combination. For example, FIGS. 50 and 51 provide the lead into GAME ONE, similarly to FIGS. 40 and 41. In the event of a multiple winning combination, such as that shown in FIG. 56, the double up option is in respect of all the credits that are awarded for all winning combinations. In this case, the winning combinations are four contiguous images of the character NAN along one of the designated lines, and two contiguous images of the character JUNIOR along another of the designated lines. As the NAN character was presented in a greater number of images than the JUNIOR character, the character “assisting” the player progress is NAN.

The machine also provides as a winning combination the contiguous disposition of five like character images along a given designated line. For this machine, there are five reels and, as such, five contiguous like characters is the maximum obtainable. However, in other embodiments more or less reel are used. The gaming sequence for five contiguous like characters is schematically illustrated by the screen dumps of FIGS. 58 to 65. As best illustrated in FIGS. 58 and 59, the lead into this type of winning combination is the same as that of the other games. That is, FIG. 58 is, for all intents and purposes the same as FIGS. 40 and 50, while FIG. 59 is, for all intents and purposes, the same as FIGS. 41 and 51.

With the game having been actuated and the winning combination of five contiguous like images displayed along a designated line, the like images flash and the music associated with the respective character is played to the gamer. This is schematically illustrated in FIG. 60 where the character the subject of the winning combination is POP. The controller then drives display 1 to present to the gamer an animated image of POP providing a win statement that is specific to POP. This is schematically illustrated in FIG. 61. As this animation is occurring, the awarded gaming credits for the win are added to any accumulated credits already held by the gamer. When the win statement has been delivered, controller 3 progresses to the double up mode, as shown in FIG. 62, again making use of the same character POP. This continuity of character allows the gamer to follow through the gaming sequences with less repetition, and therefore lowering the risk of the gamer growing tired of the game. Moreover, the characters use encouraging language to “side with” the gamer. In some cases of a loose sequence, the language conveyed from the character to the gamer is consoling.

There are six characters available in this game, and all are available to constitute winning combinations of five like contiguous characters. However, the underlying operation of the machine is the same, notwithstanding that the gamer is provided with considerable variation in the images and virtual characters that are displayed. By way of another example, a winning combination for based upon five contiguous images of the character JUNIOR is schematically illustrated in FIGS. 63 to 65.

In this embodiment it is particularly advantageous for the characters to appear humanoid and empathetic to the gamer's success or failure.

In addition to the gamer participating in a game for gaming credits, the machine of the present embodiment also allows the gamer to participate in a game a chance for other goods and/or services. These goods and services are those which are supplied by parties who wish to use the medium of the gaming machine to reach a desired audience including the gamer. That is, the parties, in the context of this embodiment, are advertisers or promoters of goods and/or services. In some embodiments, the cost of the advertising is offset against a nominal value of the goods and services that are provided by the advertiser or promoter for being awarded as prizes.

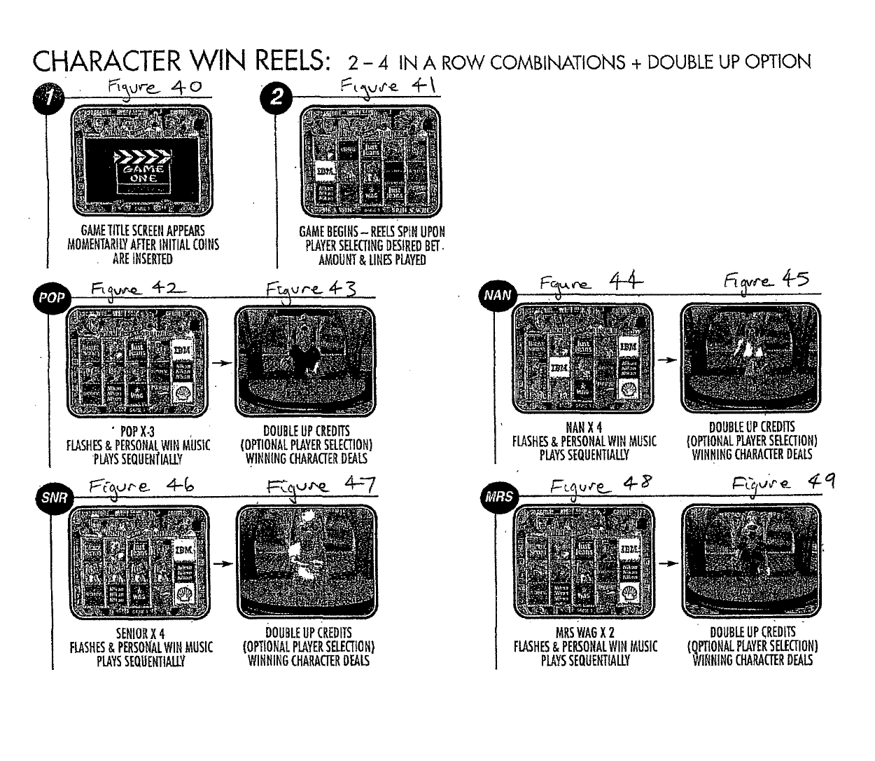

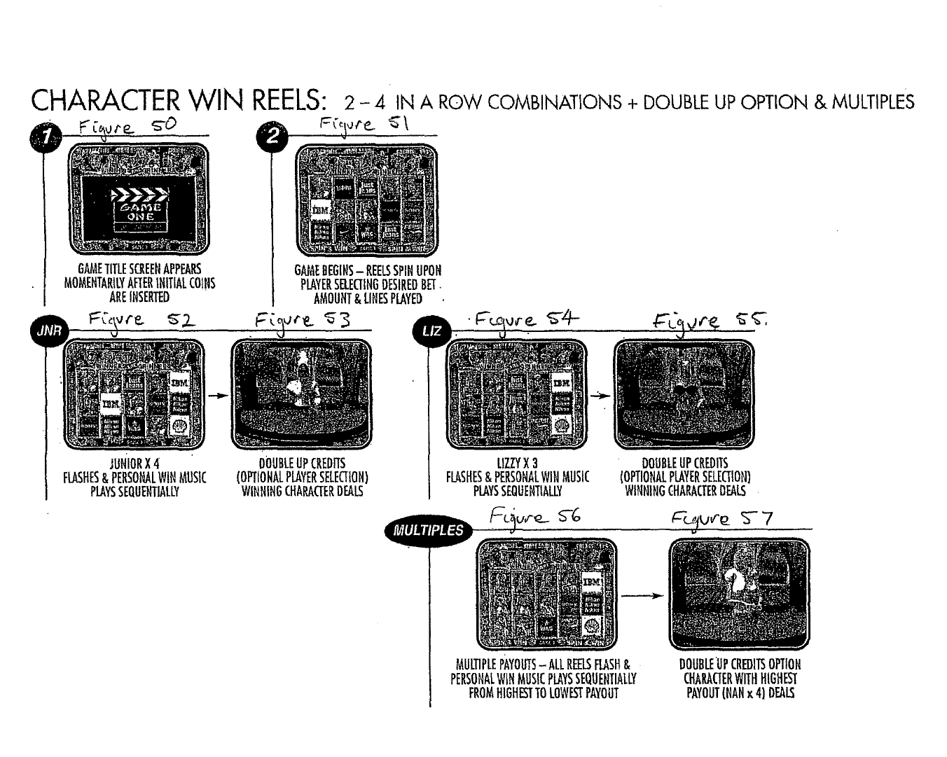

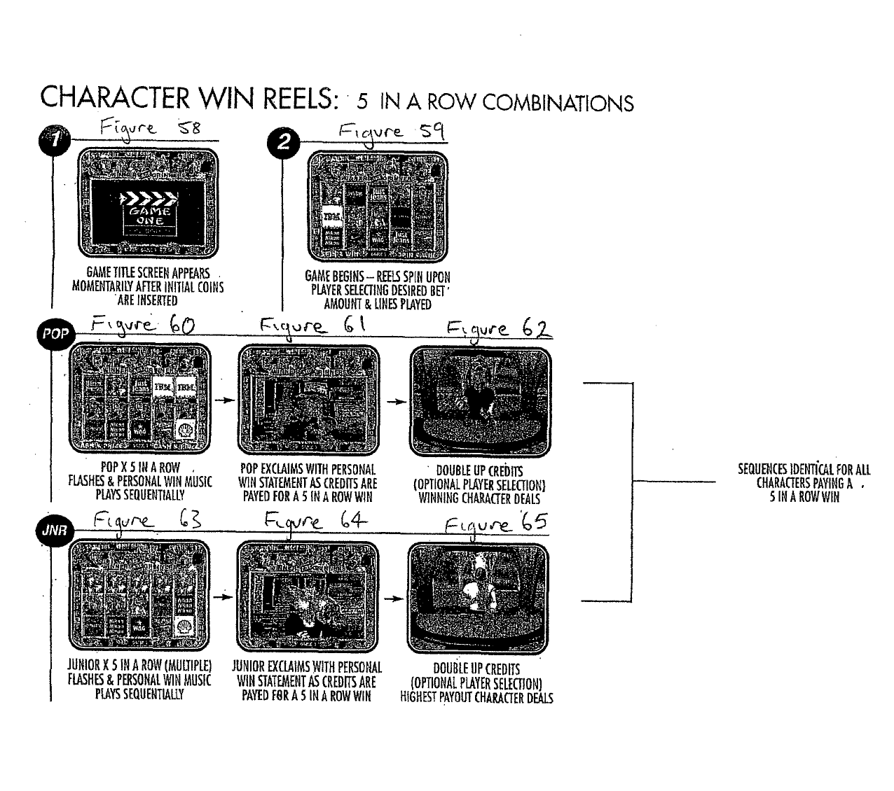

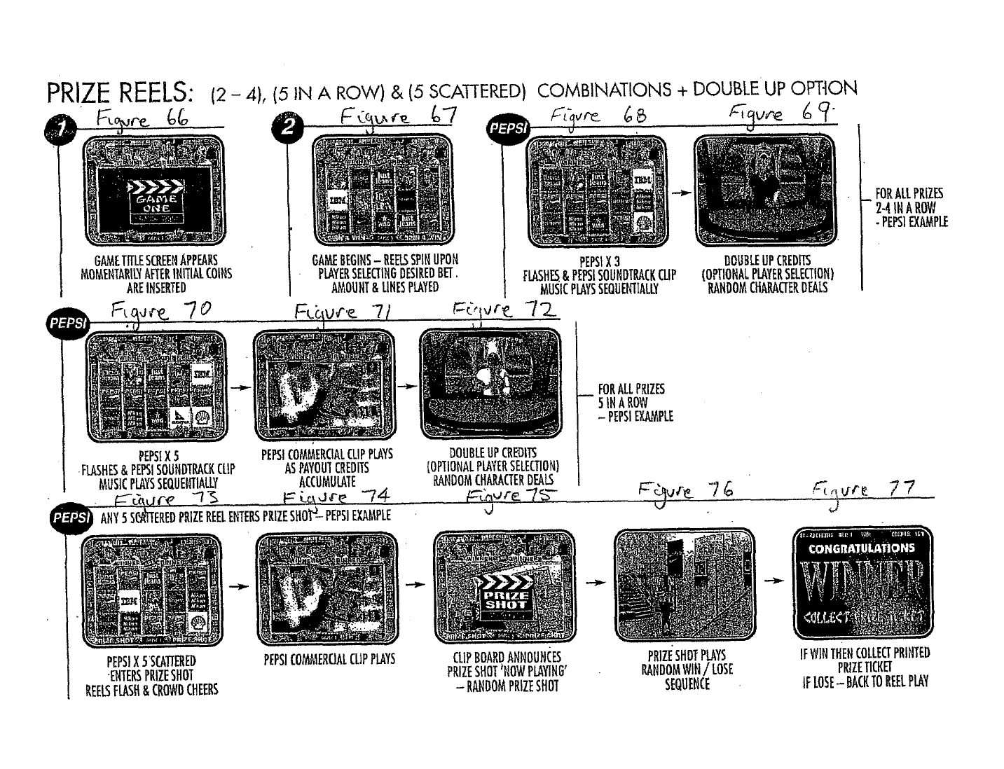

In FIGS. 66 and 67 it is shown that the game is commenced by the gamer in the usual manner. In the event of a winning combination of icons—that is, any two, three or four contiguous icons disposed along a line that was designated by the gamer—then that winning combination flashes for a predetermined time and, simultaneously, is accompanied by a theme song or tune for the advertiser or product in question. For example, in the present embodiment, three PEPSI® icons are contiguously disposed along a winning line as shown in FIG. 68. The PEPSI® icons flash and the theme song for the relevant product, in this case PEPSI MAX soft drink, is also played. The prize awarded in this circumstance is, in addition to credits, a can of the soft drink. In some establishments, and for some prizes, the additional prize is redeemable at the establishment. This is particularly convenient for products such as food or drink, as the establishments that provide gaming machines usually also have facilities to vend food and drinks. In this embodiment, the machine prints a voucher that the gamer collects to redeem the additional prize. The gaming credits are accumulated in the usual manner.

It will be appreciated that in some embodiments, the prize for this winning combination is gaming credits only.

The machine then progresses to the double up option, as is the case for two, three or four contiguously displayed like characters. This is shown in FIG. 69 and the operation in this part of the game is the same as that described above with reference to the characters. It will be appreciated that the character that assists the gamer with the double up option is randomly chosen. However, in other embodiments, the characters are progressively chosen. In still further embodiments, no character is used.

Where the maximum, for this machine, of five contiguous like icons are disposed along a designated line, this also provides a winning combination. For the case of five PEPSI® icons, such as that illustrated in FIG. 70, the icons flash, as would be the case for five contiguous character images. However, rather than progressing to a congratulatory message from a character, the display presents the user with a 15 second video clip that plays out while the relevant credits are accumulating. This is represented in the screen dump of FIG. 71. After the clip has finished, the game progresses to the double up sequence, as shown in FIG. 72. In this case, the prize that is awarded is gaming credits and preferably more credits than is the case of two, three or four contiguous icons.

A combination of five icons in a scattered configuration—that is, one icon being shown on each virtual reel—also represents a winning combination. However, once this combination is established, the machine enters a different sequence. Initially, and as shown in FIG. 73, the relevant icons flash and the sound of a cheering crowd is made audible to the gamer. This combination does not result in any gaming credits being awarded to the gamer but, rather, allows the gamer to participate in another game of chance that entitles him or her to win a prize that is associated with the icon concerned.

For the example of FIG. 73 the icon is that of PEPSI®. The next step is that a video clip, also associated with the icon, plays for 15 seconds or another time period that is considered appropriate. This is shown in FIG. 74. As there are no gaming credits awarded, there is no need to accumulate credits at this time. Instead, the controller progress to a prize shot sequence that commences with an image as shown in FIG. 75. The next image, or sequence of images, that is displayed to the gamer include an animation involving one or more of the characters. This animation includes a sporting scene of some kind where the character or characters are attempting to complete a sporting task where the outcome, at least in so far as the gamer is concerned, is uncertain. In FIG. 76 there is illustrated the JUNIOR character at the start of an animation of that character which involves the attempted placement of a basketball within the hoop, where the throw is taken from the free throw line. If the shot is made successfully, the gamer is provided with the image of FIG. 77 and wins a product associated with the icon. In this case, the prize is a PEPSI MAX® soft drink and the machine prints a voucher or ticket for the gamer. This ticket is presented to redeem the prize.

If the shot is unsuccessful, the character provides a consoling comment and the gamer returns to the previous succession of games.

Also included in the prize shot plays is subliminal advertising for other advertisers wishing to make use of this medium.

The character chosen to complete the sporting task is randomly determined. However, in some embodiments, that determination is pseudo-random or progressive. In all these cases, the character is presented together with the music that has been assigned to that character and the character sounds some words that suggest that successful completion of the task is sincerely being sought. Immediately prior to the character attempting the task it is usual to reduce the volume of or discontinue the assigned music.

In some embodiments the games include icons that bear indicia of the establishment in which the machines are located. These icons are also available to form winning combinations. In the present embodiment, there are icons for the administrator or the advertising, these icons bearing the designation WAG. In the event of a scattered combination of the WAG icons, such as that illustrated in FIG. 78, those icons flash and music plays that is associated with the special feature functionality of the game. More particularly, there are six special features that are provided by the game, where these features are accessed sequentially and interspersed with many other standard games. That is, a gamer has to spend a considerable amount of uninterrupted playing time to complete all six special features. Should the gamer leave the machine, the machine will, after the “time out” referred to above, reset to game one.

The time between special features is adjustable, and is usually different for each feature. That is, as the gamer progresses, each of the succession of games is longer. In one example, GAME ONE includes fifty successive games and at least ten prize reels, while GAME TWO includes seventy five successive games and fifteen prize reels, and so on.

Once the special feature has been awarded, the special feature sequence of FIGS. 79 to 82 is followed. That is, there is a count down sequence, as represented in FIG. 79, followed by an indication as to what number of special feature is to be viewed. This is shown in FIG. 80, where it is clear that the special feature to be viewed is the first special feature. A clipboard, such as that shown in FIG. 81, announces the special feature and, finally, that feature is played, as schematically represented in FIG. 82.

The special feature presents to the gamer a continuous story line or theme, in the form of an animated video clip, that involves one or more of the characters. That is, the video clip of the second special feature follows the theme or story of the first video clip and so on. In this embodiment the video clips of the special features take the form of situational comedies involving the characters such that the gamer is able to develop an understanding or relationship with those characters. This then provides the gamer with entertainment, as well as allowing him or her to be more inclined to respond to subsequent displays of the characters in the standard game or prize shots.

The videos of the special features also make use of subliminal advertising methods.

Where the special feature being viewed is the final special feature, the gaming sequence is represented in FIGS. 83 to 88. That is, the first steps are similar to any other special feature. In particular, FIGS. 83 to 87 are functionally equivalent to FIGS. 78 to 82, although the images presented to the gamer a far different. However, as this is the last special feature, following the showing of the video clip, the game progresses to an image that is illustrated in FIG. 88. Moreover, the gamer is provided with a lottery ticket as a reward for having completed the entire sequence. The lottery ticket is either printed by the machine or, alternatively, the machine prints a voucher that is redeemable by the gamer for the awarded lottery ticket.

The game then resets are returns to GAME ONE.

As illustrated in FIGS. 89 and 90, the WAG icon is also used as a substitute for any one of the characters and, as such, allows additional winning combinations to be produced. The character that assists the gamer through the double up option is that character represented in the images that made up the winning combination.

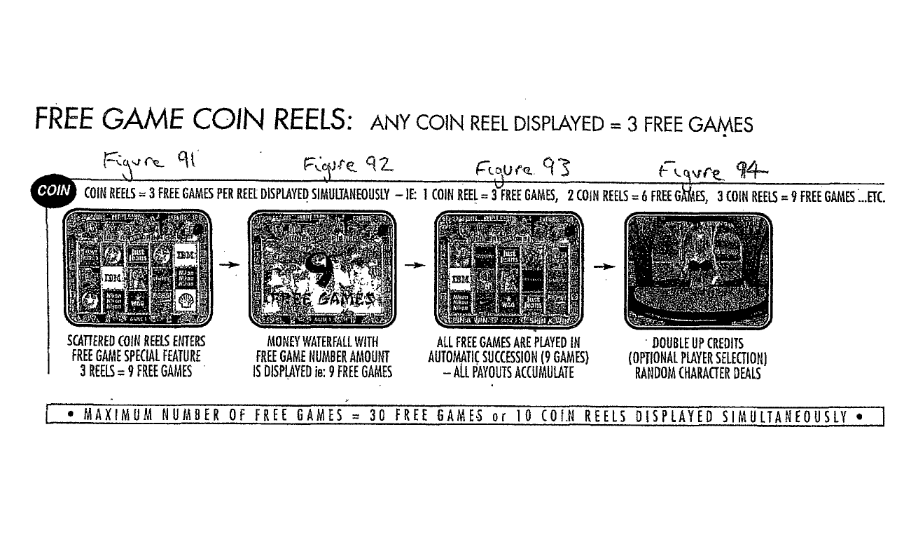

Another feature of the game of the second embodiment is shown in FIGS. 91 to 94. More particularly, in addition to gaming credits, prize shots and special features, the game also includes winning combinations that award free games to the gamer. The free game icons are marked with a coin in this embodiment, although other visually distinctive icons are used in other embodiments. For each of the free game icons that falls on a line designated by the gamer, that gamer is awarded three free games up to a maximum of thirty free games. In FIG. 91 there are three free game icons disposed on the lines designated by the gamer and, as shown in FIG. 92, nine free games are awarded to the gamer. The games are played automatically and all payouts of gaming credits accumulate. In the event that the accumulation is not nil, then the game progresses to the double up option, as shown in FIG. 94. The character involved in the double up sequence is chosen at random.

Upon one or more of the coin icons being disposed upon the required line, the machine progresses to a win sequence that includes providing the gamer with a visual representation of coins flowing down a waterfall. That is, the coins are interposed with the water.

The possible winning combinations provided by the game are many and varied. For example, not only are character image combinations available, but also icon images. Moreover, multiple wins are possible where the character combinations are along one designated line and icon combinations along another.

Usually, the scattered icon combinations go to prizes that are not provided by the gaming establishment and therefore are not problematic in that they do not affect the ratio of the revenue returned to the gamer. That is, the non-gaming credit prizes are provided to the gainer by the administrator of the machines or the advertisers.

There is continuity through the game not only of the story line in the special features but also of the music associated with the characters. This provides additional connection of the gamer with the game and betters the gamer's recollection of the game. The use of video and audible instruction, from the characters and other sources, is also beneficial.

In other embodiments the special features include video type games such as virtual golf shots or PACMAN® style games. That is, the interaction with the gamer is increased over prior art machines.

The game of the present embodiment includes outward features, such as some elements of the display during the standard game, that are familiar to a gamer who has experience with prior gaming machines. However, the many other features of this embodiment add additional entertainment and reward value than is provide by the prior art.

In some embodiments, the game is conducted over a network of interlinked gaming machines. In other embodiments, the game is played over the internet wherein the necessary software is downloaded prior to gaming or, alternatively, a CD or other storage medium is provided to the gamer.

Although the invention has been described with reference to specific examples, it will be appreciated by those skilled in the art that the invention may be embodied in many other forms.

1. A method of displaying a game on a gaming machine including a display, the method including the steps of
(a) displaying a plurality of game segments on the display;
(b) displaying a video sequence before, during or after one or more of the game segments.

2. A method according to claim 1 wherein the video sequence shows an animated character doing one or more of:
(i) interacting with another animated character;
(ii) performing a task; or
(iii) interacting with a user.

3. A method according to claim 2 wherein the step of displaying a video sequence showing an animated character interacting with another animated character includes the step of displaying the character in a special feature sequence.

4. A method according to claim 3 wherein the step of displaying the character in a special feature sequence includes the step of displaying the character doing one or more of:
(a) acting out a sketch;
(b) telling a joke; or
(c) observing or participating in a sport related situation.

5. A gaming machine for displaying a game, the gaming machine including a display which:
(a) displays a plurality of game segments; and
(b) displays a video sequence before, during or after one or more of the game segments.

6. A machine according to claim 5 wherein the video sequence shows an animated character doing one or more of:
(i) interacting with another animated character;
(ii) performing a task; or
(iii) interacting with a user.

7. A machine according to claim 6 wherein the display displays the video sequence showing the animated character interacting with the other animated character by displaying the characters in a special feature sequence.

8. A machine according to claim 7 wherein the display displays the characters in a special feature sequence by displaying the characters doing one or more of:
(a) acting out a sketch;
(b) telling a joke; or
(c) observing or participating in a sport related situation.

9. A method of generating advertising revenue using a gaming machine having a display, the method including the steps of:
(a) displaying a plurality of game segments on the display;
(b) displaying a video sequence before, during or after one or more of the game segments, wherein the video sequence includes advertising information provided by an advertiser; and
(c) receiving revenue from the advertiser in return for displaying their advertising information on the gaming machine.

10. A method according to claim 9 wherein the advertising information includes one or more of:
(a) television style commercials;
(b) slide show style commercials; and
(c) subliminal advertising information.

11. A method according to claim 10 wherein the subliminal advertising information includes advertising information displayed on the display in or on one or more of:
(a) an animated character's clothing;
(b) an animated character's hand;
(c) a poster in the background of a scene;
(d) an animated display in the background of a scene; or
(f) another object in the background of a scene.

12. A gaming machine including:
a housing;
an actuator mounted to the housing for allowing a gamer to play a game, the actuator being responsive to manual input from the gamer for providing input signals;
a display mounted to the housing for operating selectively in a game mode for displaying the progress of the game to the gamer and an idle mode for displaying other information;
a controller contained within the housing and being responsive to the input signals for driving the display, wherein following an absence of input signals for a predetermined period, the controller drives the display in the idle mode.

13. A machine according to claim 12 wherein, in the idle mode, the display provides visual or audible promotion of the game.

14. A machine according to claim 12 wherein, in the idle mode, the display provides visual or audible promotion of a product and/or service of an advertiser.

15. A machine according to claim 12 wherein the machine keeps a record of the quantum of gaming credits that the gamer has accumulated, and the controller is responsive to that record for driving the display in the idle mode only if the quantum is zero.

16. A machine according to claim 13 wherein the machine is contained within a network, and the controller communicates with the network to provide display data indicative of the when the display was driven in the idle mode and the promotion that was displayed.

17. A method of operating a gaming machine, the method including:
providing a housing;
mounting an actuator mounted to the housing for allowing a gamer to play a game, the actuator being responsive to manual input from the gamer for providing input signals;
mounting a display mounted to the housing for operating selectively in a game mode for displaying the progress of the game to the gamer and an idle mode for displaying other information;
utilising a controller contained within the housing to be responsive to the input signals for driving the display, wherein following an absence of input signals for a predetermined period, the controller drives the display in the idle mode.

18. A gaming machine for allowing a gamer to play a game that provides the gamer with a finite chance of winning awarded gaming credits, the machine including:
a housing;
a register for storing gaming credits that are available to the gamer;
an actuator mounted to the housing for allowing the gamer to play the game, the actuator being responsive to manual input from the gamer for providing input signals;
a display mounted to the housing for displaying the progress of the game to the gamer;
a controller contained within the housing and being responsive to the input signals and the register for driving the display wherein, following a predetermined win of the game by the gamer, the register is progressively increased by the awarded credits while the controller simultaneously drives the display to display to the gamer a video sequence.

19. A machine according to claim 18 wherein the game includes a plurality of virtual reels that each bear a plurality of characters.

20. A machine according to claim 19 wherein the win corresponds to two or more of the same character on different reels being displayed in a given spatial relationship on the display.

21. A machine according to claim 20 wherein the same character on the different reels is also the subject of the video sequence.

22. A machine according to claim 18 wherein the video sequence includes an audio component such that the gamer perceives that the character is talking to the gamer.

23. A gaming machine including:
a housing;
an actuator mounted to the housing for allowing a gamer to play a game, the actuator being responsive to manual input from the gamer for providing input signals;
a display mounted to the housing for displaying the progress of the game to the gamer;
a controller contained within the housing and being responsive to the input signals for driving the display such that for predetermined outcomes of the game the display provides the gamer with visual and/or audible instructions as to how to progress the game.

24. A machine according to claim 23 wherein the display provides the gamer with visual and audible instructions.

25. A machine according to claim 24 wherein the game includes a plurality of distinct characters that are selectively animated on the display to provide the instructions.

26 A method of gaming including:
allowing a gamer to play a game by providing manual input signals;
providing a display for displaying the progress of the game to the gamer;
being responsive to the input signals for driving the display such that for predetermined outcomes of the game the display provides the gamer with visual and/or audible instructions as to how to progress the game.

27. A gaming machine for allowing a gamer to play a succession of games of chance that are based upon a plurality of characters, the machine including:
a housing;
an actuator mounted to the housing for allowing the gamer to play the game, the actuator being responsive to manual input from the gamer for providing input signals;
a display mounted to the housing for operating in a first mode for displaying to the gamer the progress of the present game in the succession of games and a second mode for displaying to the gamer an animated sequence of one or more of the characters;
a controller contained within the housing and being responsive to the input signals for driving the display such that the first mode is interspersed with the second mode and the successively displayed animated sequences include continuity.

28. A machine according to claim 27 wherein the continuity of the successively displayed animated sequences is in respect of an underlying story line that is being followed by the characters.

29. A machine according to claim 28 wherein the animated sequences are associated with respective feature games that provide the gamer with finite chances of winning a prize.

30. A method for allowing a gamer to play a succession of games of chance that are based upon a plurality of characters, the method including:
allowing a gamer to play a game by providing manual input signals;
operating a display in a first mode for displaying to the gamer the progress of the present game in the succession of games and a second mode for displaying to the gamer an animated sequence of one or more of the characters;
being responsive to the input signals for driving the display such that the first mode is interspersed with the second mode and the successively displayed animated sequences include continuity.
